(19) United States
(12) Patent Application Publication
(10) Pub. No.: US 2020/0301645 A1
(43) Pub. Date: Sep. 24, 2020

(54) DISPLAY APPARATUS AND DISPLAY METHOD

(71) Applicants: Ryo FURUTANI, Kanagawa (JP); Sachiko TAKATA, London (GB)

(72) Inventors: Ryo FURUTANI, Kanagawa (JP); Sachiko TAKATA, London (GB)

(73) Assignee: Ricoh Company, Ltd., Tokyo (JP)

(21) Appl. No.: 16/745,674

(22) Filed: Jan. 17, 2020

(30) Foreign Application Priority Data
Mar. 19, 2019 (JP) 2019-052008

(51) Int. Cl. G06F 3/14; G06F 3/041; G06F 3/01

(52) U.S. Cl. CPC G06F 3/1454; G06F 3/016; G06F 3/0414

(57) ABSTRACT

A display apparatus includes a display with a display surface, at least two data input devices, and circuitry. The circuitry detects, from the at least two data input devices, a data input device to which data is input, generates an instruction receiving image including an instruction receiving section to receive an instruction from a user, and displays the instruction receiving image on the display surface. The instruction receiving section is arranged at a position according to a result of the detection.

### CROSS-REFERENCE TO RELATED APPLICATION

This patent application is based on and claims priority pursuant to 35 U.S.C. § 119(a) to Japanese Patent Application No. 2019-052008 filed on Mar. 19, 2019 in the Japan Patent Office, the entire disclosure of which is hereby incorporated by reference herein.

### BACKGROUND

### Technical Section

The present invention relates to a display apparatus and a display method.

### Description of the Related Art

There is a display apparatus such as an electronic whiteboard implemented as a flat panel display equipped with a touch panel. With the touch panel, the display apparatus detects the coordinates of a position on a display surface of the display contacted by a pointer such as an electronic pen or a user's finger, and renders a trajectory of the coordinates on a screen of the display as a handwritten input. Thereby, a user is able to use the screen of the display as a whiteboard.

The display apparatus may be connected to a personal computer (PC) to display the screen image of the PC on the display and render the handwritten input as superimposed on the screen image.

The display apparatus may further display, on the display surface of the display, instruction receiving sections with descriptions such as “CUT OUT,” “READ DOCUMENT,” and “EXIT” to receive user instructions.

### SUMMARY

In one embodiment of this invention, there is provided an improved display apparatus that includes, for example, a display with a display surface, at least two data input devices, and circuitry. The circuitry detects, from the at least two data input devices, a data input device to which data is input, generates an instruction receiving image including an instruction receiving section to receive an instruction from a user, and displays the instruction receiving image on the display surface. The instruction receiving section is arranged at a position according to a result of the detection.

In one embodiment of this invention, there is provided an improved display method executed by a display apparatus including a display with a display surface and at least two data input devices. The display method includes, for example, detecting, from the at least two data input devices, a data input device to which data is input, generating an instruction receiving image including an instruction receiving section to receive an instruction from a user, and displaying the instruction receiving image on the display surface. The instruction receiving section is arranged at a position according to a result of the detecting.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating exemplary general arrangement of a display system according to an embodiment of the present invention;

FIG. 2 is a block diagram illustrating an exemplary hardware configuration of an electronic whiteboard in the display system of the embodiment;

FIG. 3 is a block diagram illustrating an exemplary functional configuration of the electronic whiteboard of the embodiment;

FIG. 4 is a diagram illustrating an exemplary configuration of images superimposed by the electronic whiteboard;

FIGS. 5A and 5B are diagrams each illustrating an exemplary table referred to by a user interface (UI) image generating unit of the electronic whiteboard to generate a UI image, FIG. 5A illustrating a table with identification information without a priority order, and FIG. 5B illustrating a table with the identification information with a priority order;

FIG. 6 is a conceptual diagram illustrating page data stored in the electronic whiteboard;

FIG. 7 is a conceptual diagram illustrating stroke sequence data included in the page data;

FIG. 8 is a conceptual diagram illustrating coordinate sequence data included in the stroke sequence data;

FIG. 9 is a conceptual diagram illustrating media data included in the page data;

FIG. 10 is a conceptual diagram illustrating watermark image data stored in the electronic whiteboard;

FIG. 11 is a block diagram illustrating an exemplary functional configuration of a file processing unit of the electronic whiteboard;

FIG. 12 is a block diagram illustrating an exemplary functional configuration of a server unit and a client unit of the electronic whiteboard;

FIG. 13 is a conceptual diagram illustrating operation data stored in the electronic whiteboard;

FIGS. 14 and 15 are sequence diagrams illustrating exemplary processes of electronic whiteboards in the display system;

FIG. 16 is a flowchart illustrating an exemplary process in which an electronic whiteboard of the display system receives data input from an external apparatus and displays the UI image on a display surface of the electronic whiteboard;

FIG. 17 is a diagram illustrating an example of a superimposed image displayed when an external apparatus is connected to the right side of the electronic whiteboard;

FIG. 18 is a diagram illustrating an example of a superimposed image displayed when an output image is stored in the electronic whiteboard as a still image;

FIGS. 19 and 20 are diagrams illustrating exemplary operations of an electronic whiteboard according to another embodiment of the present invention; and

FIGS. 21A and 21B are diagrams illustrating exemplary operations of an electronic whiteboard according to still another embodiment of the present invention, FIG. 21A illustrating the electronic whiteboard displaying UIs, and FIG. 21B illustrating the electronic whiteboard not displaying the UIs.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. In the drawings illustrating embodiments of the present invention, members or components having the same function or shape will be denoted with the same reference numerals to avoid redundant description.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

A typical display apparatus such as an electronic whiteboard displays instruction receiving sections on the right side thereof, as viewed from a position facing the electronic whiteboard. Therefore, when a user stands by the left side of the display apparatus, as viewed from the position facing the electronic whiteboard, and inputs instructions to the display apparatus by touching the instruction receiving sections, for example, it may be inconvenient for the user to perform the instruction input operation owing to the distance from the user standing by the left side of the display apparatus to the instruction receiving sections displayed on the right side of the display apparatus.

There is a display apparatus allowing the user to change the display position of the instruction receiving sections by changing user settings. Such a display apparatus, however, causes the user extra work of changing the settings. Further, the user may be unaware of how to change the display position of the instruction receiving sections.

At least one of embodiments of the present invention provides a display apparatus facilitating a user to perform the instruction input operation.

Herein, a display apparatus refers to an apparatus that displays an image. An electronic whiteboard is an example of the display apparatus. In the following description of the embodiments, the term “electronic whiteboard” will be used to describe the display apparatus.

A display surface refers to a surface of an image display device, such as a display, on which an image is displayed.

A data input device refers to a device that inputs data to the electronic whiteboard from an external apparatus. In the embodiments, the data input device is disposed on each of two opposing sides of the display surface of the electronic whiteboard.

A user interface (UI) is an example of an instruction receiving section that receives an instruction from a user to the electronic whiteboard.

An external apparatus refers to an apparatus located outside of the electronic whiteboard and connectable to the electronic whiteboard via a cable, a network, or the data input device. Examples of the external apparatus include a laptop personal computer (PC), an apparatus or device equivalent thereto, and a portable storage medium.

Identification information refers to information assigned to each of a plurality of data input devices, such as a universal serial bus (USB) port, a wired port, and an antenna, to identify the data input device. The identification information of the data input device is distinguished from the identification (ID) of infrared ray output to a sensor controller by a contact sensor. The ID of the infrared ray will be simply referred to as the ID.

The following description of the embodiments will be given of a display system including electronic whiteboards, as an example.

A configuration of a display system according to an embodiment of the present invention will be described.

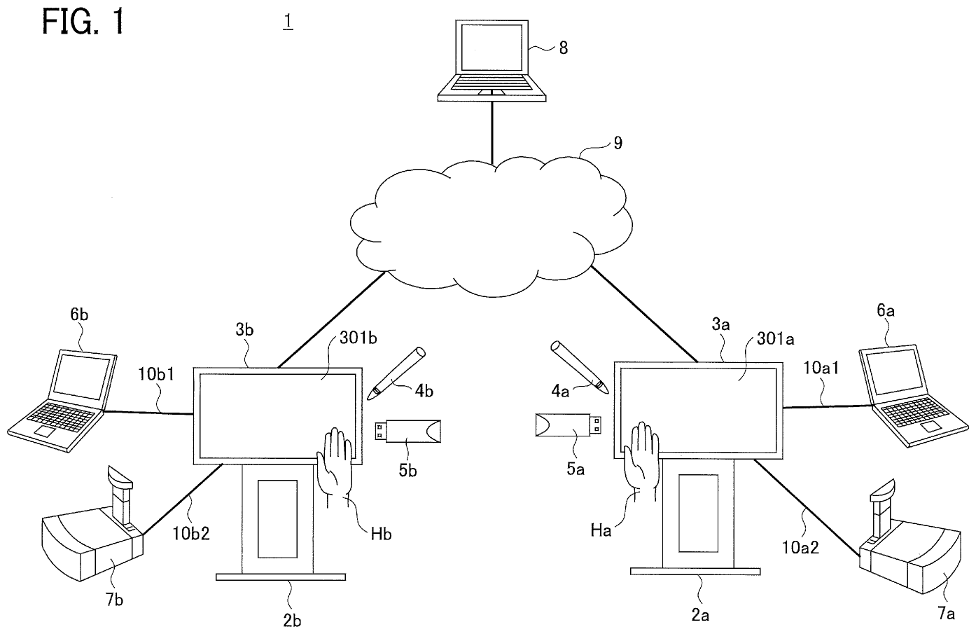

FIG. 1 is a diagram illustrating an exemplary configuration of a display system 1 according to an embodiment of the present invention. For simplification of illustration, FIG. 1 simply illustrates two electronic whiteboards 2a and 2b and accompanying electronic pens 4a and 4b. The display system 1, however, may include three or more electronic whiteboards and three or more electronic pens.

As illustrated in FIG. 1, the display system 1 includes the electronic whiteboards 2a and 2b, the electronic pens 4a and 4b, USB memories 5a and 5b, laptop PCs 6a and 6b, television (video) conference terminals (hereinafter simply referred to the television conference terminals) 7a and 7b, and a PC 8. The electronic whiteboards 2a and 2b and the PC 8 are communicably connected to each other via a communication network 9. The electronic whiteboards 2a and 2b are equipped with displays 3a and 3b, respectively. The displays 3a and 3b include display surfaces 301a and 301b, respectively.

The electronic whiteboard 2a displays, on the display 3a, an image rendered based on an event caused by the electronic pen 4a (e.g., a touch of a tip or end of the electronic pen 4a on the display 3a). The electronic whiteboard 2a further changes the image displayed on the display surface 301a of the display 3a based on an event caused by the electronic pen 4a or a user's hand Ha, for example (e.g., a gesture such as scaling-up, scaling-down, or page-turning). The electronic pen 4a and the user's hand Ha are examples of a pointer.

Each of two opposing sides of the electronic whiteboard 2a is equipped with at least one USB port connectable with the USB memory 5a. The electronic whiteboard 2a records or reads an electronic file (hereinafter simply referred to as file), such as a portable document format (PDF) file, to and from the USB memory 5a.

The electronic whiteboard 2a further includes a wired data input device that performs communication in conformity with a standard such as DisplayPort (registered trademark), digital visual interface (DVI), high-definition multimedia interface (HDMI, registered trademark), or video graphics array (VGA). The wired data input device is disposed on one side or two opposing sides of the electronic whiteboard 2a. In FIG. 1, the laptop PC 6a is connected to the wired data input device via a cable 10a1.

Herein, two opposing sides of the electronic whiteboard 2a correspond to the right and left sides in the horizontal direction of the electronic whiteboard 2a. Further, one side of the electronic whiteboard 2a corresponds to one side in the horizontal direction of the electronic whiteboard 2a. The display surface 301a is positioned at the center in the horizontal direction of the electronic whiteboard 2a. Therefore, two opposing sides of the electronic whiteboard 2a are an example of two opposing sides of the display surface 301a, and one side of the electronic whiteboard 2a is an example of one side of the display surface 301a.

In response to an event on the display 3a such as contact thereon, the electronic whiteboard 2a transmits event information of the event to the laptop PC 6a similarly as in response to an event on an input device such as a mouse or keyboard.

The electronic whiteboard 2a is connected to the television conference terminal 7a via a cable 10a2 that enables communication conforming to the above-described standard. The electronic whiteboard 2a also includes a wireless data input device that performs wireless communication in conformity with a wireless communication protocol such as the infrared or Bluetooth (registered trademark) protocol. The wireless data input device is disposed on each of two opposing sides of the electronic whiteboard 2a or on one side of the electronic whiteboard 2a not equipped with the wired data input device. The electronic whiteboard 2a is thereby capable of wirelessly communicating with the laptop PC 6a.

At a site different from a site of the electronic whiteboard 2a, the electronic whiteboard 2b with the display 3b, the electronic pen 4b, the USB memory 5b, the laptop PC 6b, the television conference terminal 7b, and cables 10b1 and 10b2 are used similarly as described above. The electronic whiteboard 2b also changes the image displayed on the display 3b based on an event caused by a user's hand Hb, for example.

With the above-described configuration, the image rendered on the display 3a of the electronic whiteboard 2a at one site is also displayed on the display 3b of the electronic whiteboard 2b at another site. Similarly, the image rendered on the display 3b of the electronic whiteboard 2b at the another site is also displayed on the display 3a of the electronic whiteboard 2a at the one site. The display system 1 thus enables a remote sharing process of sharing the same image between multiple remote sites, and therefore is convenient for use in a conference or meeting between remote sites, for example.

Hereinafter, a given one of the electronic whiteboards 2a and 2b will be described as the electronic whiteboard 2, and a given one of the displays 3a and 3b will be described as the display 3. Further, a given one of the electronic pens 4a and 4b will be described as the electronic pen 4, and a given one of the USB memories 5a and 5b will be described as the USB memory 5. Similarly, a given one of the laptop PCs 6a and 6b will be described as the laptop PC 6, and a given one of the television conference terminals 7a and 7b will be described as the television conference terminal 7. Further, a given one of the user's hands Ha and Hb will be described as the user's hand H, and a given one of the cables 10a1, 10a2, 10b1, and 10b2 will be described as the cable 10.

The following description of the embodiment will be given of the electronic whiteboard 2 as an example of the display apparatus, but the display apparatus is not limited thereto. Other examples of the display apparatus include digital signage, a telestrator for use in sport news or weather forecast presentation, for example, and remote image (video) diagnostic equipment. Further, the following description will also be given of the laptop PC 6 as an example of the external apparatus. The external apparatus, however, is not limited thereto. Other examples of the external apparatus include apparatuses capable of supplying image frames, such as a desktop PC, a tablet PC, a personal digital assistant (PDA), a smartphone, a digital video camera, a digital camera, and a game console. Further, the communication network 9 includes the Internet, a local area network (LAN), and a mobile phone communication network, for example. The following description of the embodiment will further be given of the USB memory 5 as an example of a recording medium. The recording medium, however, is not limited thereto. Other examples of the recording medium include various recording media such as a secure digital (SD) card.

A hardware configuration of the electronic whiteboard 2 of the embodiment will be described.

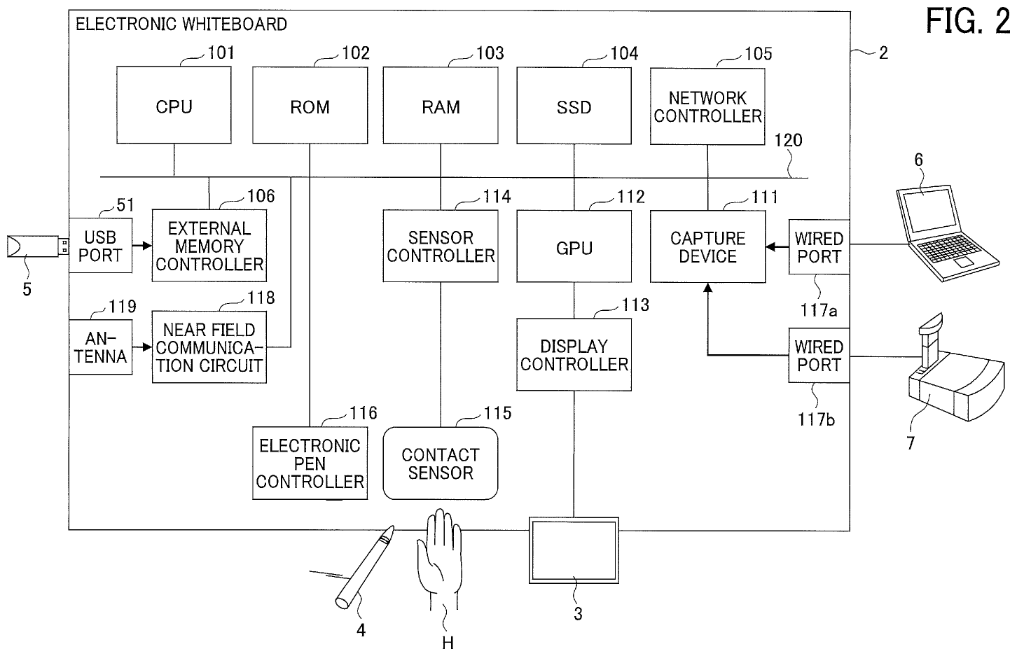

FIG. 2 is a block diagram illustrating an exemplary hardware configuration of the electronic whiteboard 2 of the embodiment. As illustrated in FIG. 2, the electronic whiteboard 2 includes a central processing unit (CPU) 101, a read only memory (ROM) 102, a random access memory (RAM) 103, a solid state drive (SSD) 104, a network controller 105, and an external memory controller 106.

The CPU 101 controls an overall operation of the electronic whiteboard 2. The ROM 102 stores a program used to drive the CPU 101 such as an initial program loader (IPL). The RAM 103 is used as a work area for the CPU 101. The SSD 104 stores various data of a program for the electronic whiteboard 2, for example. The network controller 105 controls communication with the communication network 9. The external memory controller 106 controls communication with the USB memory 5 via a USB port 51.

The electronic whiteboard 2 further includes a capture device 111, a graphics processing unit (GPU) 112, a display controller 113, wired ports 117a and 117b, a near field communication circuit 118, and an antenna 119 for the near field communication circuit 118.

The capture device 111 inputs image information from the external apparatus such as the laptop PC 6 as a still or video image. The GPU 112 is a device dedicated to processing of graphics. The display controller 113 controls and manages screen display to output an image from the GPU 112 to the display 3, for example. The image information input from the external apparatus by the capture device 111 is displayed on the display 3 of the electronic whiteboard 2 via the GPU 112 and the display controller 113.

The wired ports 117a and 117b conform to a standard such as DisplayPort, DVI, HDMI, or VGA, as described above. The image information from the PC 6 is input to the capture device 111 via the wired port 117a, and image information from the television conference terminal 7 is input to the capture device 111 via the wired port 117b. The near field communication circuit 118 is a communication circuit conforming to a standard such as near field communication (NFC) or Bluetooth. The image information from the laptop PC 6 or the television conference terminal 7 may be input to the electronic whiteboard 2 through wireless communication via the antenna 119 and the near field communication circuit 118.

Herein, the USB port 51, the wired ports 117a and 117b, and the antenna 119 are examples of the data input device. In the present embodiment, the USB port 51 and the antenna 119 are disposed on the left side (i.e., the left side in FIG. 2) of the electronic whiteboard 2, and the wired ports 117a and 117b are disposed on the right side (i.e., the right side in FIG. 2) of the electronic whiteboard 2.

FIG. 2 illustrates an example in which the electronic whiteboard 2 includes one USB port 51, two wired ports 117a and 117b, and one antenna 119. However, the respective numbers of these data input devices are not limited thereto. The electronic whiteboard 2 may include one or more USB ports, one or more wired ports, and one or more antennas.

Further, the electronic whiteboard 2 may include one or more wired ports conforming to part or all of standards such as DisplayPort, DVI, HDMI, and VGA and one or more antennas conforming to part or all of standards such as NFC and Bluetooth.

The electronic whiteboard 2 further includes a sensor controller 114, a contact sensor 115, an electronic pen controller 116, and a bus line 120.

The sensor controller 114 controls the processing of the contact sensor 115 that detects the contact of the electronic pen 4 or the user's hand H, for example, on the display 3. The contact sensor 115 performs input and detection of coordinates in accordance with an infrared ray blocking method. According to this method of inputting and detecting coordinates, two light emitting and receiving devices disposed on opposite end portions on the upper side of the display 3 emit rays of infrared light parallel to the display 3, and receive the rays of infrared light reflected by reflecting members disposed around the display 3 and returning on the same optical paths as those of the rays of infrared light emitted by the light emitting and receiving devices.

The contact sensor 115 outputs, to the sensor controller 114, the IDs of the rays of infrared light emitted from the two light emitting and receiving devices and blocked by an object. Then, the sensor controller 114 identifies a coordinate position corresponding to the contact position of the object on the display 3.

The method employed by the contact sensor 115 is not limited to the infrared ray blocking method. The contact sensor 115 may include various detectors such as a capacitive touch panel that identifies the contact position by detecting a change in capacitance, a resistive touch panel that identifies the contact position based on a change in voltage of two facing resistance films, or an electromagnetic induction touch panel that identifies the contact position by detecting electromagnetic induction caused by the contact of an object on the display 3.

The electronic pen controller 116 communicates with the electronic pen 4 to determine whether there is a touch of the tip or end of the electronic pen 4 on the display 3. The electronic pen controller 116 may also determine whether there is a touch on the display 3 by a part of the electronic pen 4 other than the tip or end thereof, such as a part of the electronic pen 4 held by the user.

The bus line 120 includes buses such as an address bus and a data bus to electrically connect the CPU 101, the ROM 102, the RAM 103, the SSD 104, the network controller 105, the external memory controller 106, the capture device 111, the GPU 112, the sensor controller 114, and the electronic pen controller 116, as illustrated in FIG. 2.

The program for the electronic whiteboard 2 may be distributed as recorded on a computer-readable recording medium, such as a compact-disc (CD)-ROM.

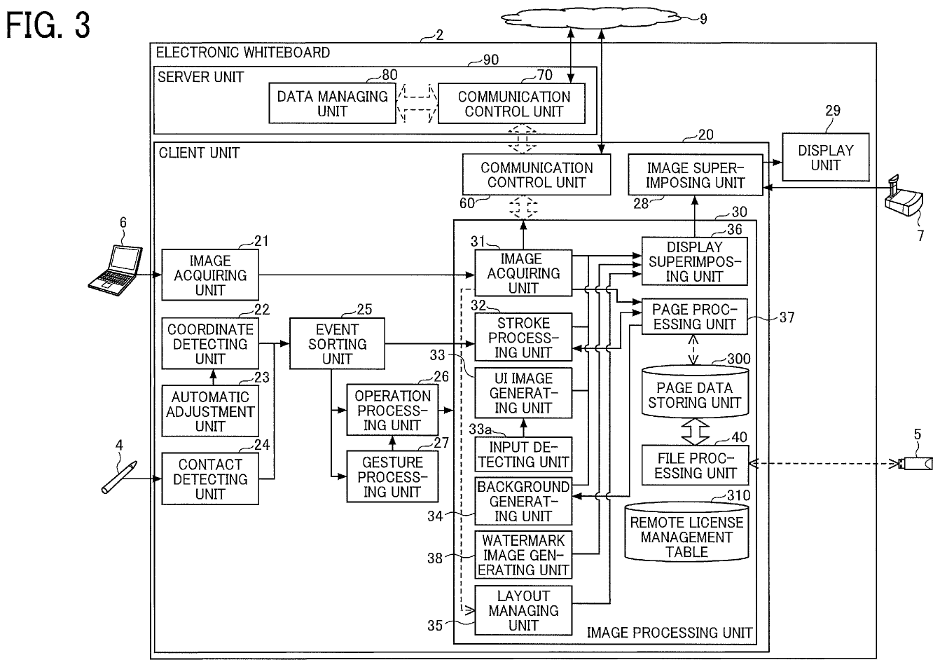

A functional configuration of the electronic whiteboard 2 of the embodiment will be described with FIGS. 3 to 12. An overall functional configuration of the electronic whiteboard 2 will first be described with FIG. 3.

FIG. 3 is a block diagram illustrating an exemplary functional configuration of the electronic whiteboard 2 of the embodiment. The electronic whiteboard 2 includes functional units illustrated in FIG. 3, which are implemented by the hardware components and programs described above with FIG. 2.

The electronic whiteboard 2 may serve as a host apparatus that starts the remote sharing process or as a participant apparatus that, when the remote sharing process has already started, joins the remote sharing process.

The electronic whiteboard 2 includes two major units: a client unit 20 and a server unit 90. The client unit 20 and the server unit 90 are functions implemented within a housing of one electronic whiteboard 2. When the electronic whiteboard 2 serves as the host apparatus, the client unit 20 and the server unit 90 are implemented in the electronic whiteboard 2. When the electronic whiteboard 2 serves as the participant apparatus, the client unit 20 is implemented in the electronic whiteboard 2, but the server unit 90 is not implemented in the electronic whiteboard 2.

For example, when the electronic whiteboard 2a and the electronic whiteboard 2b in FIG. 1 serve as the host apparatus and the participant apparatus, respectively, the client unit of the electronic whiteboard 2a communicates with the client unit 20 of the electronic whiteboard 2b via the server unit 90 implemented in the electronic whiteboard 2a. The client unit 20 of the electronic whiteboard 2b, on the other hand, communicates with the client unit 20 of the electronic whiteboard 2a via the server unit 90 implemented in the electronic whiteboard 2a.

A functional configuration of the client unit 20 will be described with FIGS. 3 to 12.

The client unit 20 includes an image acquiring unit 21, a coordinate detecting unit 22, an automatic adjustment unit 23, a contact detecting unit 24, an event sorting unit 25, an operation processing unit 26, a gesture processing unit 27, an image superimposing unit 28, an image processing unit 30, and a communication control unit 60.

The image acquiring unit 21 acquires an output image from an image output apparatus (e.g., the laptop PC 6) connected to the wired data input device or the wireless data input device of the electronic whiteboard 2. The image acquiring unit 21 receives an image signal from the image output apparatus, analyses the image signal to derive image information therefrom, and outputs the image information to an image acquiring unit 31 of the image processing unit 30. The image information includes the resolution of the image frame of the image displayed by the image output apparatus, i.e., the image formed by the image signal, and the frequency of updating the image frame. The image output apparatus is an example of the external apparatus, and is specifically a laptop PC, a smartphone, or a tablet PC, for example.

When acquiring the image from the image output apparatus by wire via the wired port 117a or 117b, the image acquiring unit 21 directly acquires, as the image signal, the image of the screen displayed on a display of the image output apparatus.

When wirelessly acquiring the image from the image output apparatus via the antenna 119, the image acquiring unit 21 directly acquires, as the image signal, the image of the screen displayed on the display of the image output apparatus, or may acquire a file, such as an image file, from a memory of the image output apparatus.

When acquiring a file, the image acquiring unit 21 may automatically acquire a predetermined type of file, such as a portable network graphics (PNG) file, from the image output apparatus wirelessly connected to the electronic whiteboard 2, or may acquire therefrom a user-specified file. Further, the image acquiring unit 21 may acquire a file stored in a user-specified folder of a plurality of folders stored in the image output apparatus.

The coordinate detecting unit 22 detects the coordinate position at which an event caused on the display 3 by the user (e.g., action such as touching the display 3 with the user's hand H) has occurred. The coordinate detecting unit 22 also detects the dimensions of the touched area.

The automatic adjustment unit 23 is started at the start or restart of the electronic whiteboard 2 to adjust parameters for image processing such that the coordinate detecting unit 22 outputs appropriate values. In this image processing, the coordinate detecting unit 22, which detects coordinates by using an optical sensor, processes the image of a sensor camera.

The contact detecting unit 24 detects the event caused by the user (e.g., action such as touching (pressing) the display 3 with the tip or end of the electronic pen 4).

The event sorting unit 25 sorts the coordinate positions of events detected by the coordinate detecting unit 22 and results of detection by the contact detecting unit 24 into events: stroke rendering, UI operation, and gesture operation.

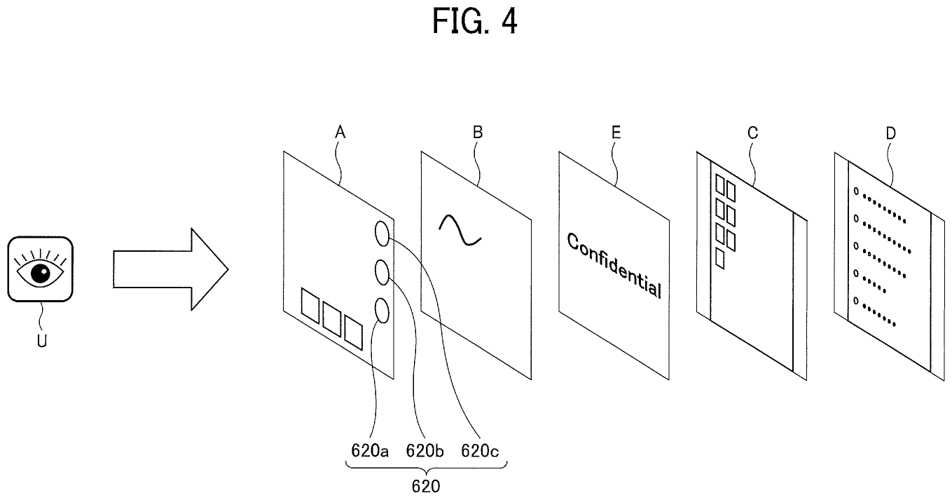

Herein, the stroke rendering refers to an event in which the user presses the electronic pen 4 against the display 3, moves the electronic pen 4 over the display 3 with the electronic pen 4 kept pressed thereon, and releases the electronic pen 4 from the display 3, to thereby display a stroke image B in FIG. 4 on the display 3.

With the stroke rendering, a letter such as an alphabetic letter “S” or “T,” for example, is rendered on the display 3. As well as the event of rendering an image, events such as deleting and editing a rendered image are also included in the stroke rendering.

The UI operation refers to an event in which, when a UI image A in FIG. 4 is displayed on the display surface 301 of the display 3, the user presses a predetermined position on the display surface 301 with the electronic pen 4 or the user's hand H. The UI operation corresponds to an instruction issued to the electronic whiteboard 2 by the user to operate the electronic whiteboard 2. The UI operation is therefore an example of a user instruction.

The UI operation is performed to set parameters such as the color and width of the line rendered with the electronic pen 4. The UI operation may also be performed to store the image displayed on the display 3 into the electronic whiteboard 2 as a still image, or to input the image of the external apparatus (e.g., the laptop PC 6) connected to the electronic whiteboard 2 into the electronic whiteboard 2.

The gesture operation refers to an event in which, when the stroke image B in FIG. 4 is displayed on the display 3, the user touches the display 3 with the user's hand H or moves the user's hand H over the display 3. With the gesture operation, such as moving the user's hand H while in contact with the display 3, for example, the user is able to perform an operation such as scaling up or down an image, changing a display area, or switching pages, for example.

The operation processing unit 26 executes various operations in accordance with UI elements at which events are caused, starting with the operation determined as the UI operation by the event sorting unit 25. The UI elements include buttons, lists, checkboxes, and textboxes, for example. The gesture processing unit 27 executes the operation determined as the gesture operation by the event sorting unit 25.

The image superimposing unit 28 displays a superimposed image on a display unit 29 as an image. The superimposed image includes images superimposed by a display superimposing unit 36 of the image processing unit 30. The display unit 29 is a display function implemented by the display 3. The image superimposing unit 28 further superimposes, on the image from the image output apparatus (e.g., the laptop PC 6), the image from another image output apparatus (e.g., the television conference terminal 7) in the picture-in-picture format. The image superimposing unit 28 further switches between the image displayed in a part of the display unit 29 in the picture-in-picture format and the image displayed on the entire display unit 29.

The image processing unit 30 executes processes such as a process of superimposing images as illustrated in FIG. 4. The image processing unit 30 includes an image acquiring unit 31, a stroke processing unit 32, a UI image generating unit 33, a background generating unit 34, a watermark image generating unit 38, a layout managing unit 35, a display superimposing unit 36, a page processing unit 37, a file processing unit 40, a page data storing unit 300, a remote license management table 310, and an input detecting unit 33a. These functional units except the input detecting unit 33a are implemented by the GPU 112 in FIG. 2, and the input detecting unit 33a is implemented by the CPU 101 in FIG. 2.

The image acquiring unit 31 acquires, as the image, each of frames of the image acquired by the image acquiring unit 21, and outputs the data of the image to the page processing unit 37. This image corresponds to an output image C in FIG. 4 from the image output apparatus (e.g., the laptop PC 6).

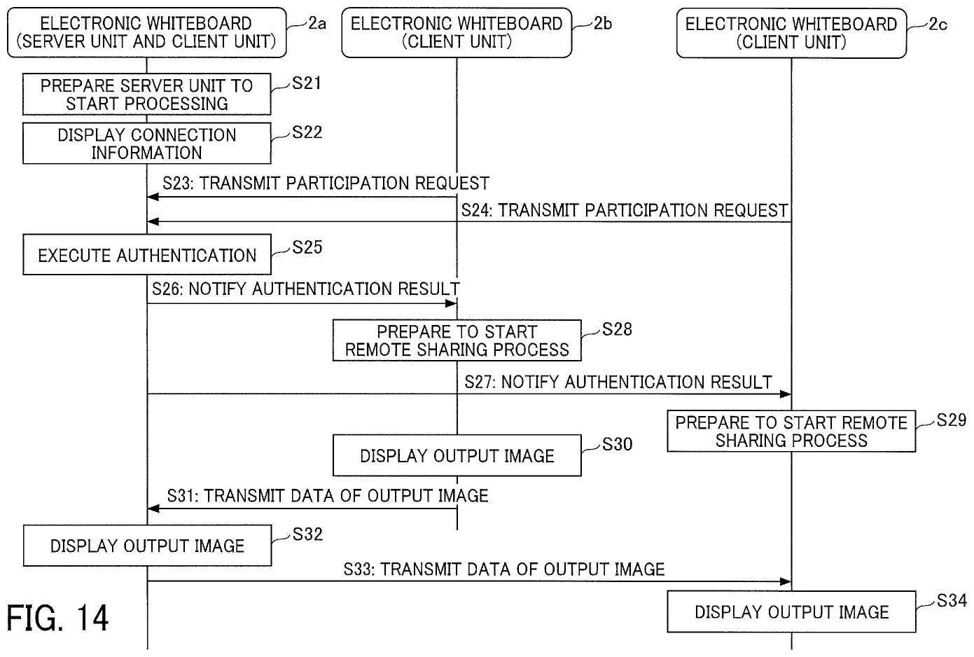

Based on the event sorted as the stroke rendering by the event sorting unit 25, the stroke processing unit 32 renders an image or deletes or edits a rendered image. The image generated based on the stroke rendering corresponds to the stroke image B in FIG. 4. The result of rendering, deletion, or editing of the image based on the stroke rendering is stored in an operation data storing unit 840 in FIG. 12 as operation data.

From the USB port 51, the wired port 117a, the wired port 117b, and the antenna 119 (i.e., an example of at least two data input devices), the input detecting unit 33a detects the data input device to which data is input.

The input detecting unit 33a detects connection of an external apparatus to at least one of the USB port 51, the wired port 117a, the wired port 117b, and the antenna 119, and detects the data input device to which data is input.

Further, the input detecting unit 33a previously associates the identification information assigned to each of the USB port 51, the wired port 117a, the wired port 117b, and the antenna 119 with information representing the right side or the left side of the electronic whiteboard 2, and outputs the identification information to the UI image generating unit 33 as a detection result.

The UI image generating unit 33 generates a UI image previously set in the electronic whiteboard 2. The UI image is an example of an instruction receiving image, and corresponds to the UI image A in FIG. 4. In the example of FIG. 4, the UI image A includes UIs 620a, 620b, and 620c for the user to perform the UI operation. Via the UIs 620a, 620b, and 620c, the electronic whiteboard 2 receives instructions from the user (i.e., UI operations). In the following description, the UIs 620a, 620b, and 620c will be simply described as the UIs 620.

Based on the identification information of the data input device detected by the input detecting unit 33a, the UI image generating unit 33 generates the UI image A with the UIs 620 arranged on one side of the electronic whiteboard 2 connected to the external apparatus. More specifically, if the external apparatus is connected to the left side of the electronic whiteboard 2, the UI image generating unit 33 generates the UI image A with the UIs 620 arranged therein to be displayed on the left side of the display surface 301. If the external apparatus is connected to the right side of the electronic whiteboard 2, the UI image generating unit 33 generates the UI image A with the UIs 620 arranged therein to be displayed on the right side of the display surface 301. If a plurality of external apparatuses are connected to two opposing sides of the electronic whiteboard 2, the UI image generating unit 33 generates the UI image A with the UIs 620 arranged therein to be displayed on two opposing sides of the display surface 301.

Based on the identification information input from the input detecting unit 33a, the UI image generating unit 33 acquires the image for forming the UI image with reference to a table, and generates the UI image with the acquired image.

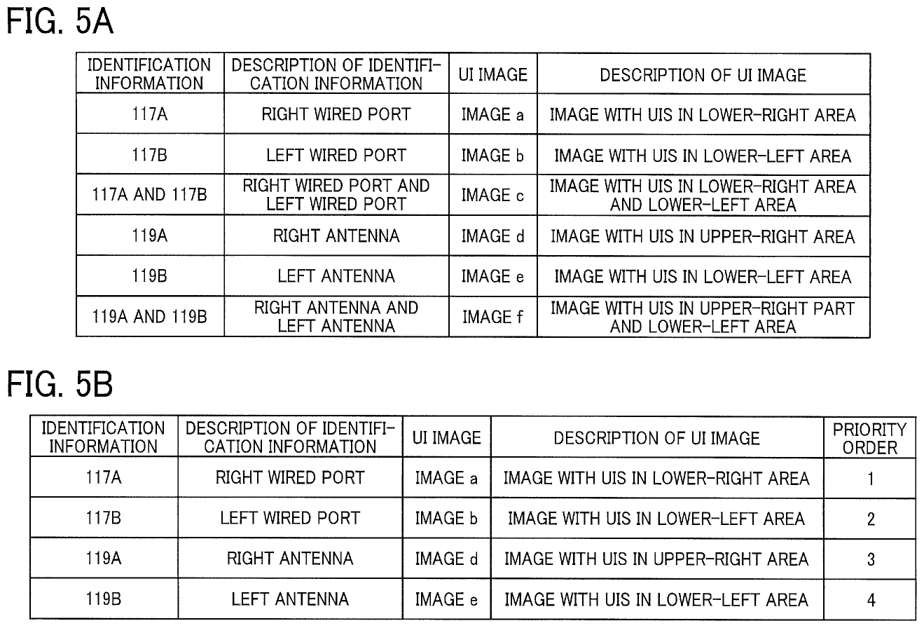

FIGS. 5A and 5B are diagrams each illustrating an exemplary table referred to by the UI image generating unit 33 to generate the UI image. In the tables of FIGS. 5A and 5B, the identification information is included in the leftmost column, and description of the identification information is included in the second leftmost column. Further, the image for forming the UI image is included in the third leftmost column, and description of the UI image is included in the fourth leftmost column. As illustrated in FIGS. 5A and 5B, the identification information and the UI image are associated with each other. The tables of FIGS. 5A and 5B are previously created and stored in a memory such as the SSD 104.

Based on the identification information input from the input detecting unit 33a, the UI image generating unit 33 acquires the image for forming the UI image with reference to the table of FIG. 5A or 5B, to thereby generate the UI image.

In the present embodiment, when the input detecting unit 33a detects the input of data to a plurality of data input devices, the UI image may be generated in accordance with a predetermined priority order of the identification information. The table of FIG. 5A includes the identification information without the priority order, and the table of FIG. 5B includes the identification information with the priority order.

When using the table of FIG. 5B with the priority order in response to the detection of data input to a plurality of data input devices by the input detecting unit 33a, the UI image generating unit 33 generates the UI image based on the identification information of the highest priority.

The background generating unit 34 receives, from the page processing unit 37, media data included in page data read from the page data storing unit 300 by the page processing unit 37. The background generating unit 34 outputs the received media data to the display superimposing unit 36. The image based on the media data corresponds to a background image D illustrated in FIG. 4. The background image D has a pattern such as a plain pattern or a grid pattern.

The watermark image generating unit 38 outputs, to the display superimposing unit 36, watermark image data stored in the page data storing unit 300 as a memory of the electronic whiteboard 2. The watermark image data corresponds to a watermark image E illustrated in FIG. 4. The watermark image generating unit 38 processes the watermark image data stored in the page data storing unit 300 to adjust the resolution and the aspect ratio of the watermark image data to match those of the display 3, for example.

Information of the transparency of the watermark image E may previously be included in the watermark image data, or may be set in the electronic whiteboard 2 by the user. In other words, the watermark image data of the watermark image E may include at least the information of the transparency of the watermark image E.

The layout managing unit 35 manages layout information representing the layout of the images output to the display superimposing unit 36 from the image acquiring unit 31, the stroke processing unit 32, the UI image generating unit 33 or the background generating unit 34, and the watermark image generating unit 38.

The layout managing unit 35 thereby transmits, to the display superimposing unit 36, an instruction as to the respective positions of the output image C, the stroke image B, and the watermark image E in the UI image A or the background image D, at which the output image C, the stroke image B, and the watermark image E should be displayed or should not be displayed.

Based on the layout information output from the layout managing unit 35, the display superimposing unit 36 lays out (i.e., superimposes) the respective images output from the image acquiring unit 31, the stroke processing unit 32, the UI image generating unit 33 or the background generating unit 34, and the watermark image generating unit 38.

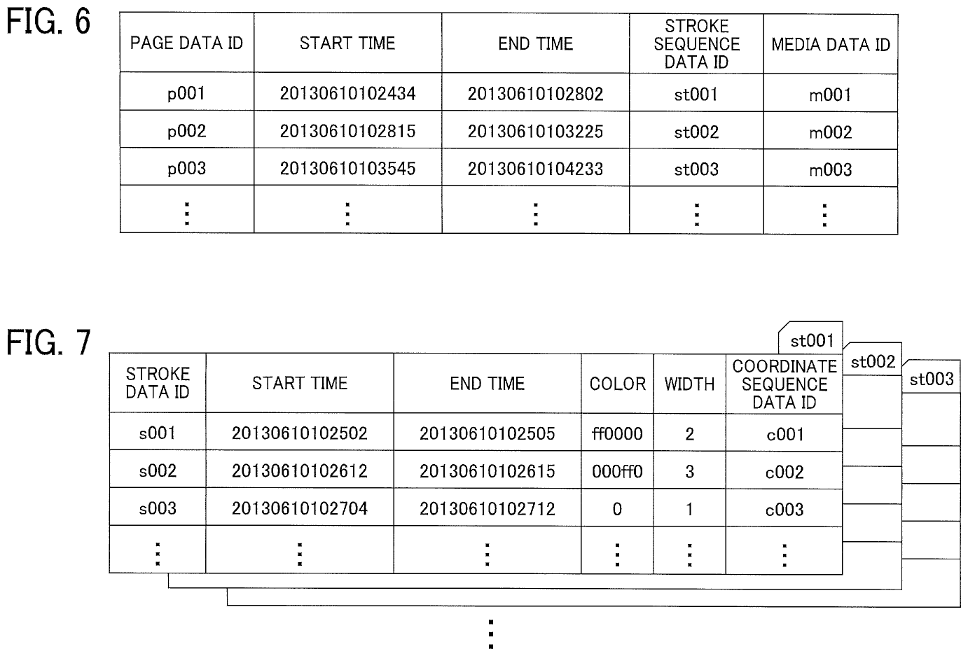

The page processing unit 37 stores the data of the stroke image B and the data of the output image C in the page data storing unit 300 as one page data item. The data of the stroke image B forms a part of the page data item as stroke sequence data (i.e., stroke data items) represented by a stroke sequence data ID illustrated in FIG. 6. The data of the output image C forms a part of the page data item as media data represented by a media data ID illustrated in FIG. 6. When the media data stored in the page data storing unit 300 is read therefrom, the read media data is handled as the data of the background image D.

Further, the page processing unit 37 may transmit the media data of the page data stored in the page data storing unit 300 to the display superimposing unit 36 via the background generating unit 34 such that the image superimposing unit 28 redisplays the background image D on the display 3. Further, the page processing unit 37 may transmit the stroke sequence data (i.e., stroke data items) of the page data back to the stroke processing unit 32 such that the stroke processing unit 32 reedits the stroke. The page processing unit 37 may also delete or duplicate the page data.

That is, when the page processing unit 37 stores the page data in the page data storing unit 300, the data of the output image C displayed on the display 3 is stored in the page data storing unit 300. Then, when the page processing unit 37 reads the thus-stored data of the output image C from the page data storing unit 300, the data of the output image C is read as the media data representing the background image D.

The page processing unit 37 further outputs the stroke sequence data representing the stroke image B to the stroke processing unit 32. The stroke sequence data is included in the page data read from the page data storing unit 300. The page processing unit 37 also outputs the media data representing the background image D to the background generating unit 34. The media data is included in the page data read from the page data storing unit 300.

The page processing unit 37 further transmits the watermark image data stored in the page data storing unit 300 to the watermark image generating unit 38. The watermark image generating unit 38 transmits the watermark image E to the display superimposing unit 36.

The display superimposing unit 36 superimposes the output image C from the image acquiring unit 31, the stroke image B from the stroke processing unit 32, the UI image A from the UI image generating unit 33, the background image D from the background generating unit 34, and the watermark image E from the watermark image generating unit 38 in accordance with the layout specified by the layout managing unit 35. Thereby, the UI image A, the stroke image B, the watermark image E, the output image C, and the background image D are superimposed upon each other in the order making each of the superimposed images viewable to a user U, as illustrated in FIG. 4.

The display superimposing unit 36 may superimpose one of the output image C and the background image D in FIG. 4 on the UI image A, the stroke image B, and the watermark image E by switching between the output image C and the background image D, i.e., by setting an exclusive relationship between the output image C and the background image D. For example, when the cable 10 connecting the electronic whiteboard 2 and the image output apparatus (e.g., the laptop PC 6) is unplugged when the UI image A, the stroke image B, and the output image C are displayed, the display superimposing unit 36 may remove the output image C from the superimposed images, and may display the background image D in accordance with the layout specified by the layout managing unit 35. In this case, the layout managing unit 35 switches the watermark image E from a non-display state to a display state. The display superimposing unit 36 also executes processes such as scaling up the displayed image, scaling down the displayed image, and moving the display area.

The page data storing unit 300 stores page data as illustrated in FIG. 6. FIG. 6 is a conceptual diagram illustrates the page data. The page data is one page of data displayed on the display 3, i.e., the stroke sequence data (i.e., stroke data items) and the media data. Since the page data includes various parameters, the contents of the page data will be described as divided into parts illustrated in FIGS. 6 to 9.

As illustrated in FIG. 6, a page data ID, a start time, an end time, a stroke sequence data ID, and a media data ID are stored in the page data in association with each other. The page data ID is used to identify a given page. The start time represents the time at which the page starts to be displayed. The end time represents the time at which rewriting of the contents of the page based on an action such as a stroke or gesture is stopped. The stroke sequence data ID is used to identify the stroke sequence data generated based on the stroke with the electronic pen 4 or the user's hand H. The media data ID is used to identify the media data. The stroke sequence data is data for displaying the stroke image B in FIG. 4 on the display 3. The media data is data for displaying the background image D in FIG. 4 on the display 3.

According to the above-described page data, when the user writes the alphabetic letter “S” with the electronic pen 4, for example, the letter “S” is normally written in one stroke and thus is represented by one stroke data ID. When user writes the alphabetic letter “T” with the electronic pen 4, on the other hand, the letter “T” is normally written in two strokes and thus is represented by two stroke data IDs.

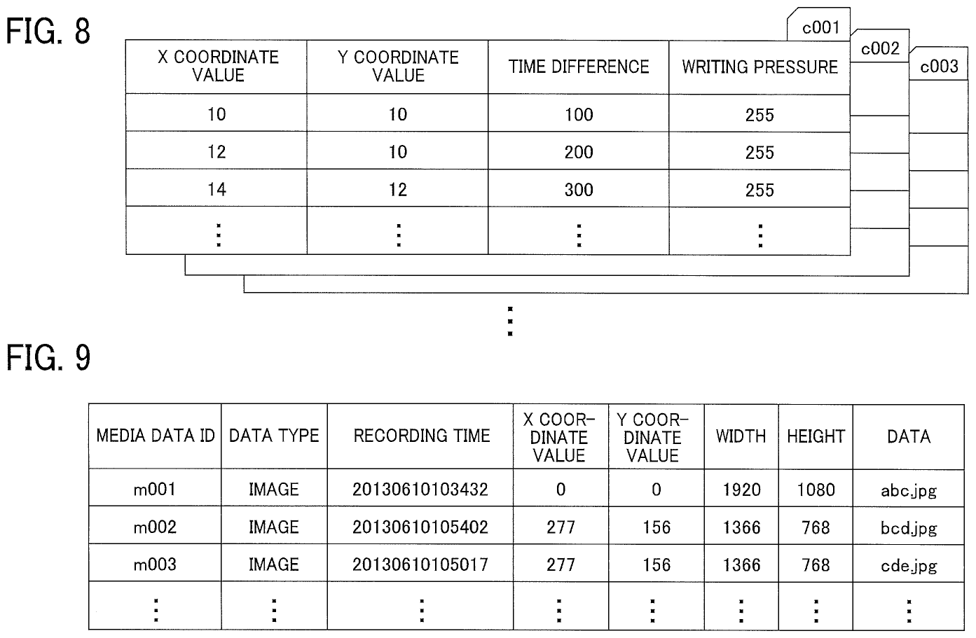

The stroke sequence data includes detailed information as illustrated in FIG. 7. FIG. 7 is a conceptual diagram illustrating the stroke sequence data. As illustrated in FIG. 7, each stroke sequence data item is represented by a plurality of stroke data items. Further, each of the stroke data items includes a stroke data ID, a start time, an end time, the color of the stroke, the width of the stroke, and a coordinate sequence data ID. The stroke data ID is used to identify the stroke data item. The start time represents the time at which a stroke starts to be written. The end time represents the time at which the writing of the stroke ends. The coordinate sequence data ID is used to identify coordinate sequence data representing a sequence of waypoints passed by the stroke.

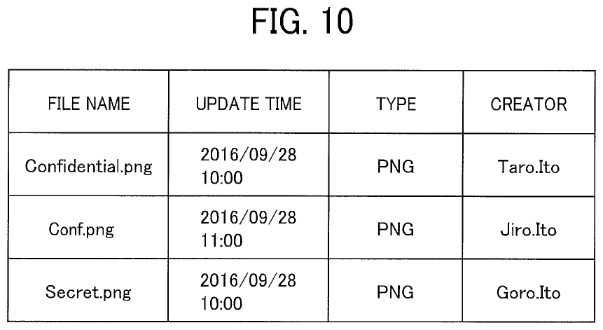

The coordinate sequence data includes detailed information as illustrated in FIG. 8. FIG. 8 is a conceptual diagram illustrating the coordinate sequence data. As illustrated in FIG. 8, the coordinate sequence data includes information items: the X coordinate value and the Y coordinate value representing a point on the display 3, the time difference (milliseconds) between the start time of the stroke and the time at which the point is passed by the stroke, and the writing pressure of the electronic pen 4 at the point. That is, a collection of points illustrated in FIG. 8 represents one coordinate sequence data item illustrated in FIG. 7. When the user writes the alphabetic letter “S” in one stroke with the electronic pen 4, for example, the stroke passes a plurality of waypoints until the user finishes writing the letter “S.” The coordinate sequence data item represents information of the plurality of waypoints.

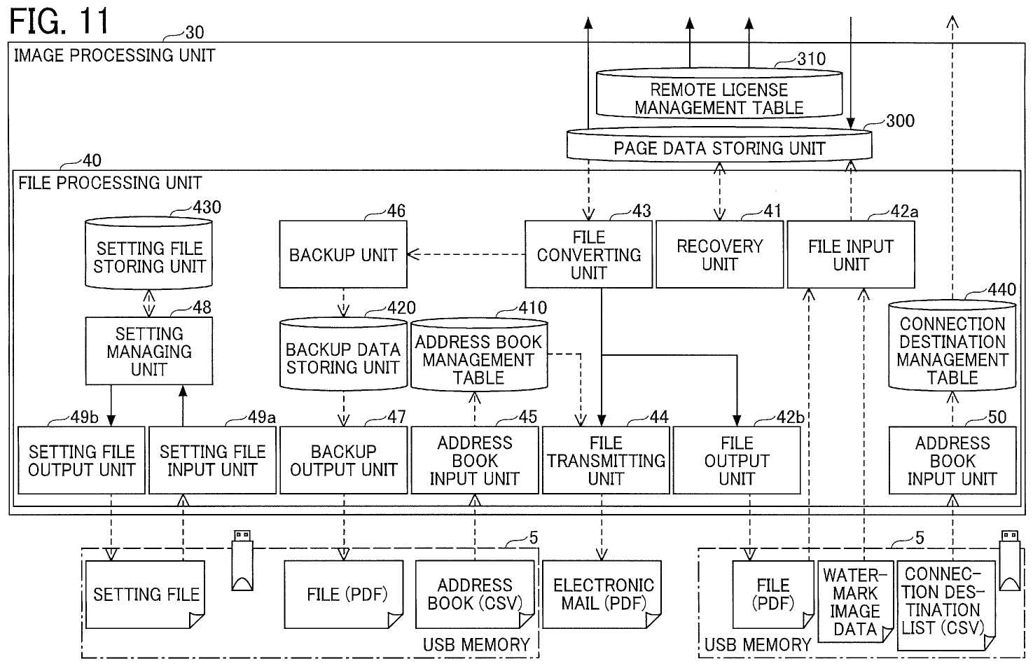

The media data included in the page data illustrated in FIG. 6 includes detailed information as illustrated in FIG. 9. FIG. 9 is a conceptual diagram illustrating the media data. As illustrated in FIG. 9, the media data includes information items: media data ID, data type, recording time, X coordinate value, Y coordinate value, width, height, and data, which are associated with each other. The media data ID is the same as that in the page data illustrated in FIG. 6. The data type represents the type of the media data. The recording time represents the time at which the page data is recorded in the page data storing unit 300 by the page processing unit 37. The X coordinate value and the Y coordinate value represent the position of the image displayed on the display 3 based on the page data. The width and the height represent the size of the image. The data represents the contents of the media data. When the coordinates of the upper-left corner of the display 3 are expressed as (X coordinate value, Y coordinate value)=(0, 0), the position of the image displayed on the display 3 based on the page data corresponds to the position of the upper-left corner of the image displayed on the display 3 based on the page data.

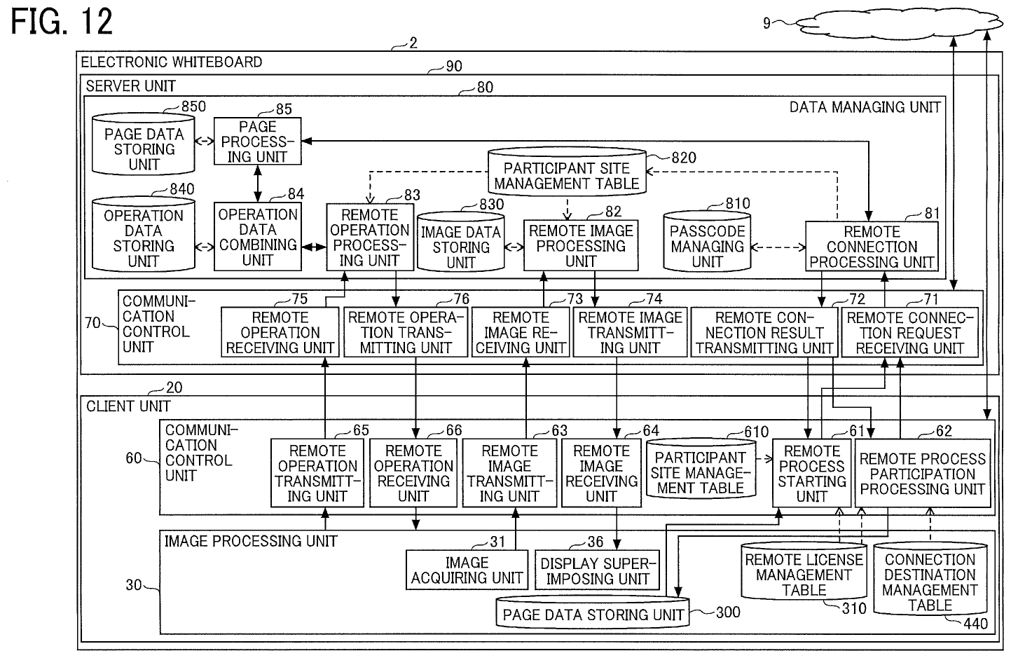

Referring back to FIG. 3, the page data storing unit 300 stores the watermark image data, which includes information as illustrated in FIG. 10. FIG. 10 is a conceptual diagram illustrating the watermark image data stored in the page data storing unit 300. As illustrated in FIG. 10, the watermark image data is stored as a file in association with information items: file name, update time, type, and creator. These information items are attributes of a file held by an information processing apparatus. Other possible attributes of a file may also be registered as the watermark image data.

Although three files are registered as the watermark image data in FIG. 10, one or more files may be registered as the watermark image data. Further, no file may be registered as the watermark image data. In this case, the watermark image is not displayed. If a plurality of files are registered as the watermark image data, one of the plurality of files is selected as appropriate for use. For example, the file of the watermark image data displayed most recently, selected by the user, updated most or least recently, or created by a logged-in user of the electronic whiteboard 2 is selected for use.

The type of the file is transmission PNG (hereinafter simply referred to as PNG) capable of handling the transparency, but may be any file type capable of expressing the transparency such as transmission graphics interchange format (GIF). If the file does not have a function of holding transparency information, the watermark image generating unit 38 may generate a transparency-controlled watermark image from a file such as a joint photographic experts group (JPEG) file.

The remote license management table 310 will now be described.

The remote license management table 310 manages license information for executing the remote sharing process. In the remote license management table 310, a product ID of the electronic whiteboard 2, a license ID for use in authentication, and an expiration period of the license are managed in association with each other as the license information.

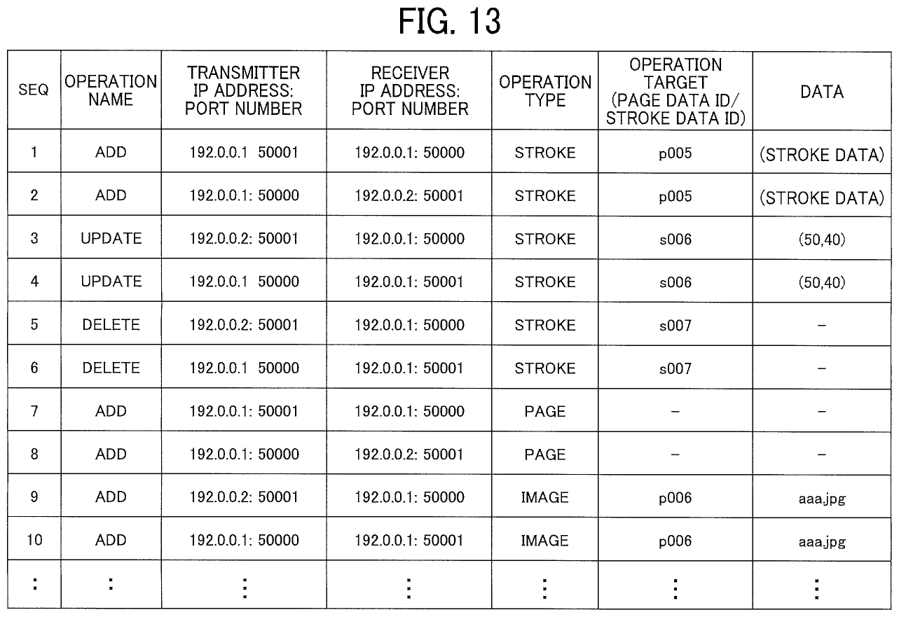

A functional configuration of the file processing unit 40 illustrated in FIG. 3 will be described with FIG. 11.

FIG. 11 is a block diagram illustrating an exemplary functional configuration of the file processing unit 40 of the embodiment. The file processing unit 40 includes a recovery unit 41, a file input unit 42a, a file output unit 42b, a file converting unit 43, a file transmitting unit 44, an address book input unit 45, a backup unit 46, a backup output unit 47, a setting managing unit 48, a setting file input unit 49a, and a setting file output unit 49b.

The file processing unit 40 further includes an address book management table 410, a backup data storing unit 420, a setting file storing unit 430, and a connection destination management table 440.

In the event of abnormal termination of the electronic whiteboard 2, the recovery unit 41 detects the abnormal termination and recovers unsaved page data. For example, when the electronic whiteboard 2 is normally terminated, the page data is recorded on the USB memory as a PDF file via the file processing unit 40. In the event of abnormal termination of the electronic whiteboard 2 due to a power failure, for example, the page data recorded in the page data storing unit 300 remains therein without being read therefrom. When the electronic whiteboard 2 is powered on again, therefore, the recovery unit 41 reads the page data from the page data storing unit 300 to recover the page data.

The file input unit 42a reads a PDF file from the USB memory 5, and stores each page of the PDF file in the page data storing unit 300 as the page data. The file converting unit 43 converts the page data stored in the page data storing unit 300 into a file in the PDF format.

The file input unit 42a further acquires image data such as the watermark image data, and stores the image data in the page data storing unit 300. The file input unit 42a may automatically acquire a predetermined type of file, such as a PNG file, from the USB memory connected to the electronic whiteboard 2, or may acquire a user-specified file from the UBS memory 5 and copy the acquired file in the page data storing unit 300. Further, the file input unit 42a may acquire a file from a user-specified folder of a plurality of folders stored in the UBS memory 5 and copy the acquired file in the page data storing unit 300.

Further, the user may communicate with the electronic whiteboard 2 by operating a given terminal and input the watermark image data to the electronic whiteboard 2 by uploading the watermark image data via a world wide web (Web) page provided by the electronic whiteboard 2. In this case, the file input unit 42a serves as a Web server. The given terminal specifies the internet protocol (IP) address of the electronic whiteboard 2 via a browser, for example, and receives from the electronic whiteboard 2 hypertext markup language (HTML) data, which is transmittable as a file. The browser receives the selection of a file by the user, and the given terminal transmits the file of the watermark image data selected by the user to the file input unit 42a. The file input unit 42a stores the file of the watermark image data in the page data storing unit 300. In other words, the file input unit 42a is capable of receiving input of (i.e., acquiring) the watermark image data with the transparency information of the watermark image E from outside the electronic whiteboard 2 and storing the thus-acquired watermark image data in the page data storing unit 300.

The file output unit 42b records the PDF file output by the file converting unit 43 on the USB memory 5.

The file transmitting unit 44 transmits the PDF file generated by the file converting unit 43 by attaching the PDF file to an electronic mail. The display superimposing unit 36 displays the contents of the address book management table 410 on the display 3, and the user operates an input device such as a touch panel to select an address from the displayed contents of the address book management table 410. Then, the file transmitting unit 44 receives the selection of the address to thereby determine the transmission destination of the PDF file. In the address book management table 410, the name and electronic mail address of the transmission destination are managed in association with each other.

The file transmitting unit 44 is also capable of receiving the electronic mail address of the transmission destination input through the user operation of the input device such as a touch panel.

The address book input unit 45 reads a file of an electronic mail address list (i.e., an address book) from the USB memory 5, and manages the file of the address book in the address book management table 410. The file of the address book is in the comma separated values (CSV) format, for example.

The backup unit 46 stores the file output by the file output unit 42b or the file transmitted by the file transmitting unit 44 into the backup data storing unit 420 to back up the file. If backup is not set by the user, the backup unit 46 does not execute the backup process. The data of the backed-up file is stored in the PDF format.

The backup output unit 47 stores the backed-up file in the USB memory 5. When storing the backed-up file in the USB memory 5, the user inputs a passcode for security by operating the input device such as a touch panel.

The setting managing unit 48 manages various setting information of the electronic whiteboard 2 by storing and reading the various setting information in and from the setting file storing unit 430. The various setting information includes network settings, date and time settings, region and language settings, electronic mail server settings, address book settings, connection destination list settings, and backup settings, for example. The network settings include setting of the IP address of the electronic whiteboard 2, netmask settings, default gateway settings, and domain name system (DNS) settings, for example.

The setting file output unit 49b records the various setting information of the electronic whiteboard 2 on the USB memory 5 as a setting file. The contents of the setting file are not viewable to the user for security reasons.

The setting file input unit 49a reads a setting file stored in the USB memory 5 and reflects various setting information of the setting file in various settings of the electronic whiteboard 2.

An address book input unit 50 reads from the USB memory 5 a file of a list of connection destination IP addresses (i.e., a connection destination list) for the remote sharing process, and manages the file of the connection destination list in the connection destination management table 440. The file of the connection destination list is in the CSV format, for example.

The connection destination management table 440 previously stores and manages the IP addresses of other electronic whiteboards 2 capable of serving as the host apparatus such that, when the electronic whiteboard 2 is going to participate in the remote sharing process as a participant apparatus, the time for the user of the participant apparatus to input the IP address of the host apparatus is saved. In the connection destination management table 440, the name of the site of each electronic whiteboard 2 capable of participating in the remote sharing process as the host apparatus and the IP address of the electronic whiteboard 2 are managed in association with each other.

The connection destination management table 440 may be removed from the electronic whiteboard 2. In this case, the user of the participant apparatus inputs the IP address of the host apparatus via an input device such as a touch panel to participate in the remote sharing process hosted by the host apparatus. The user of the participant apparatus therefore obtains the IP address of the host apparatus from the user of the host apparatus by telephone or electronic mail, for example.

A functional configuration of the communication control unit 60 will be described with FIG. 12.

FIG. 12 is a block diagram illustrating an exemplary functional configuration of the server unit 90 and the client unit 20. The communication control unit 60 controls communication of the electronic whiteboard 2 with another electronic whiteboard 2 via the communication network 9 and communication of the client unit 20 with a communication control unit 70 of the server unit 90. The communication control unit 60 includes a remote process starting unit 61, a remote process participation processing unit 62, a remote image transmitting unit 63, a remote image receiving unit 64, a remote operation transmitting unit 65, a remote operation receiving unit 66, and a participant site management table 610.

The remote process starting unit 61 transmits a request to start the remote sharing process (hereinafter referred to as the remote sharing process start request) to the server unit 90 of the electronic whiteboard 2, and receives a result of the remote sharing process start request from the server unit 90. In this process, the remote process starting unit 61 refers to the remote license management table 310. Then, if the license information (i.e., the product ID, the license ID, and the expiration period) for the remote sharing process is managed in the remote license management table 310, the remote process starting unit 61 is able to transmit the remote sharing process start request to the server unit 90. If the license information for the remote sharing process is not managed in the remote license management table 310, the remote process starting unit 61 is unable to transmit the remote sharing process start request to the server unit 90.

When the electronic whiteboard 2 serves as the host apparatus, the participant site management table 610 manages information of each electronic whiteboard 2 currently participating in the remote sharing process as the participant apparatus. In the participant site management table 610, the name of the site of the electronic whiteboard 2 participating in the remote sharing process and the IP address of the electronic whiteboard 2 are managed in association with each other.

When another electronic whiteboard 2 has already started the remote sharing process as the host apparatus, the remote process participation processing unit 62 transmits, via the communication network 9, a request to participate in the remote sharing process (hereinafter referred to as the remote sharing process participation request) to a remote connection request receiving unit 71 of the server unit 90 of the another electronic whiteboard 2 serving as the host apparatus. In this case, too, the remote process participation processing unit 62 refers to the remote license management table 310.

To participate in the already-started remote sharing process, the remote process participation processing unit 62 refers to the connection destination management table 440 and acquires the IP address of the electronic whiteboard 2 having started the remote sharing process as the host apparatus. Alternatively, the IP address of the electronic whiteboard 2 as the host apparatus may be input through the user operation of the input device such as a touch panel, with the remote process participation processing unit 62 not referring to the connection destination management table 440.

The remote image transmitting unit 63 transmits, to the server unit 90, the output image C transmitted from the image acquiring unit 21 via the image acquiring unit 31.

The remote image receiving unit 64 receives, from the server unit 90, the image data from the image output apparatus connected to another electronic whiteboard 2, and outputs the image data to the display superimposing unit 36 to enable the remote sharing process.

The remote operation transmitting unit 65 transmits various operation data for the remote sharing process to the server unit 90. The various operation data includes data related to the addition, deletion, and editing (e.g., scaling-up, scaling-down, and movement) of the stroke, the storage, generation, duplication, and deletion of the page data, and switching of the displayed page, for example. The remote operation receiving unit 66 receives, from the server unit 90, the operation data input to another electronic whiteboard 2, and outputs the operation data to the image processing unit 30 to execute the remote sharing process.

A functional configuration of the server unit 90 will be described with FIG. 12.

Each electronic whiteboard 2 includes the server unit 90 that functions as a server. The server unit 90 includes a communication control unit 70 and a data managing unit 80.

A functional configuration of the communication control unit 70 will be described with FIG. 12.

The communication control unit 70 controls communication with the communication control unit 60 of the client unit 20 in the electronic whiteboard 2 and communication with the communication control unit 60 of the client unit 20 in another electronic whiteboard 2 via the communication network 9. The data managing unit 80 manages data such as the operation data and the image data.

More specifically, the communication control unit 70 includes a remote connection request receiving unit 71, a remote connection result transmitting unit 72, a remote image receiving unit 73, a remote image transmitting unit 74, a remote operation receiving unit 75, and a remote operation transmitting unit 76.

The remote connection request receiving unit 71 receives the remote sharing process start request from the remote process starting unit 61, and receives the remote sharing process participation request from the remote process participation processing unit 62. The remote connection result transmitting unit 72 transmits a result of the remote sharing process start request to the remote process starting unit 61, and transmits a result of the remote sharing process participation request to the remote process participation processing unit 62.

The remote image receiving unit 73 receives the image data (i.e., the data of the output image C) from the remote image transmitting unit 63, and transmits the image data to a remote image processing unit 82 of the data managing unit 80. The remote image transmitting unit 74 receives the image data from the remote image processing unit 82, and transmits the image data to the remote image receiving unit 64.

The remote operation receiving unit 75 receives the operation data (e.g., the data of the stroke image B) from the remote operation transmitting unit 65, and transmits the operation data to a remote operation processing unit 83 of the data managing unit 80. The remote operation transmitting unit 76 receives the operation data from the remote operation processing unit 83, and transmits the operation data to the remote operation receiving unit 66.

A functional configuration of the data managing unit 80 will be described with FIG. 12.

The data managing unit 80 includes a remote connection processing unit 81, a remote image processing unit 82, a remote operation processing unit 83, an operation data combining unit 84, a page processing unit 85, a passcode managing unit 810, a participant site management table 820, an image data storing unit 830, an operation data storing unit 840, and a page data storing unit 850.

The remote connection processing unit 81 starts and terminates the remote sharing process. Further, based on the license information that the remote connection request receiving unit 71 receives from the remote process starting unit 61 together with the remote sharing process start request or the license information that the remote connection request receiving unit 71 receives from the remote process participation processing unit 62 together with the remote sharing process participation request, the remote connection processing unit 81 determines the presence or absence of a license. Then, if the presence of a license is determined, the remote connection processing unit 81 determines whether the license is within the expiration period. The remote connection processing unit 81 further determines whether the number of remote sharing process participation requests from other electronic whiteboards 2 as participant apparatuses is within a predetermined maximum allowed number of participant apparatuses.

The remote connection processing unit 81 further determines whether the passcode transmitted as well as the remote sharing process participation request from another electronic whiteboard 2 is the same as the passcode managed in the passcode managing unit 810. If the transmitted passcode is the same as the managed passcode, the remote connection processing unit 81 allows the another electronic whiteboard 2 to participate in the remote sharing process.

When starting the remote sharing process, the remote connection processing unit 81 issues the passcode. The passcode is then informed by the user of the electronic whiteboard 2 as the host apparatus to the user of the another electronic whiteboard 2, which is going to participate in the remote sharing process as the participant apparatus, via telephone or electronic mail, for example.

Then, the user of the another electronic whiteboard 2 that is going to participate in the remote sharing process as the participant apparatus inputs the passcode to the another electronic whiteboard 2 (i.e., the participant apparatus) via the input device such as a touch panel, to thereby transmit the remote sharing process participation request to the electronic whiteboard 2 as the host apparatus. Thereby, the another electronic whiteboard 2 is allowed to participate in the remote sharing process as the participant apparatus. When user convenience is given priority over security, the remote connection processing unit 81 may simply check the license status and omit the process of checking the passcode.

When the electronic whiteboard 2 serves as the host apparatus, the remote connection processing unit 81 stores, in the participant site management table 820 of the server unit 90, participant site information included in the remote sharing process participation request transmitted, via the communication network 9, from the remote process participation processing unit 62 of another electronic whiteboard 2 as the participant apparatus. The remote connection processing unit 81 then reads remote site information stored in the participant site management table 820, and transmits the remote site information to the remote connection result transmitting unit 72. The remote connection result transmitting unit 72 transmits the remote site information to the remote process starting unit 61 of the client unit of the electronic whiteboard 2 as the host apparatus.

The remote process starting unit 61 stores the remote site information in the participant site management table 610. In the electronic whiteboard 2 as the host apparatus, therefore, the remote site information is managed in both the client unit 20 and the server unit 90.

The remote image processing unit 82 receives image data items of the output images C from image output apparatuses (e.g., the laptop PCs 6) connected to the respective client units 20 of all electronic whiteboards 2 participating in the remote sharing process (including the client unit 20 of the electronic whiteboard 2 as the host apparatus), and stores the image data items in the image data storing unit 830. The remote image processing unit 82 further determines the order of displaying image data items in the remote sharing process based on the chronological order of arrival of the image data items arriving at the server unit 90 of the electronic whiteboard 2 as the host apparatus. With reference to the participant site management table 820, the remote image processing unit 82 then transmits the image data items to the client units 20 of all electronic whiteboards 2 participating in the remote sharing process (including the client unit 20 of the electronic whiteboard 2 as the host apparatus) in the above-determined order via the communication control unit 70 (i.e., the remote image transmitting unit 74).

The remote operation processing unit 83 receives various operation data items such as data items of the stroke images B rendered by the client units 20 of all electronic whiteboards 2 participating in the remote sharing process (including the client unit 20 of the electronic whiteboard 2 as the host apparatus), and determines the order of displaying images in the remote sharing process based on the chronological order of arrival of the various operation data items arriving at the server unit 90 of the electronic whiteboard 2 as the host apparatus. Herein, the various operation data is the same as the above-described various operation data. With reference to the participant site management table 820, the remote operation processing unit 83 then transmits the operation data items to the client units 20 of all electronic whiteboards 2 participating in the remote sharing process (including the client unit 20 of the electronic whiteboard 2 as the host apparatus) in the above-determined order.

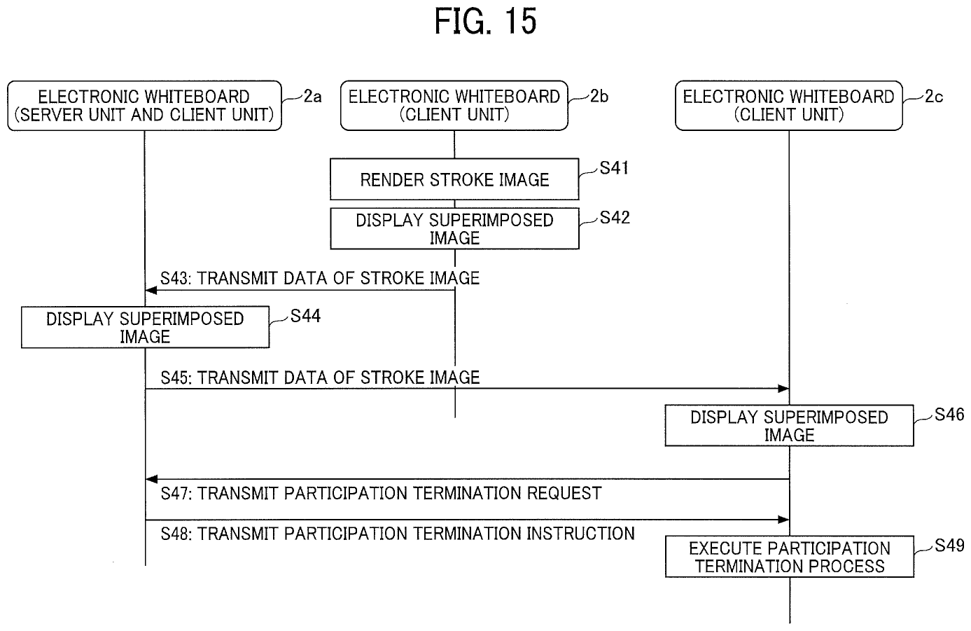

The operation data combining unit 84 combines the operation data items of the electronic whiteboards 2 output from the remote operation processing unit 83, stores operation data resulting from combining the operation data items in the operation data storing unit 840, and transmits the operation data to the remote operation processing unit 83. The operation data is then transmitted, via the remote operation transmitting unit 76, to the client unit 20 of the electronic whiteboard 2 as the host apparatus and the client unit 20 of any other electronic whiteboard 2 as the participant apparatus. Thereby, the image based on the same operation data is displayed on the respective electronic whiteboards 2. FIG. 13 illustrates an example of the operation data.

As illustrated in FIG. 13, a sequence number SEQ, an operation name, an IP address and a port number of a transmitter, an IP address and a port number of a receiver, an operation type, an operation target, and data are stored in the operation data in association with each other. Herein, SEQ represents the sequence number of the operation data. The operation name represents the name of the operation corresponding to the operation data. The IP address and the port number of the transmitter represent the IP address of the electronic whiteboard 2 as the transmitter of the operation data and the port number of the client unit 20 (or the server unit 90) of the electronic whiteboard 2 as the transmitter. The IP address and the port number of the receiver represent the IP address of the electronic whiteboard 2 as the receiver of the operation data and the port number of the client unit 20 (or the server unit 90) of the electronic whiteboard 2 as the receiver. The operation type represents the type of the operation data. The operation target represents the data to which the operation data is applied. The data represents the contents of the operation data.

For example, the first row in FIG. 13 corresponding to a sequence number SEQ1 indicates that, in response to rendering of a stroke by the client unit 20 (represented by a port number “50001”) of the electronic whiteboard 2 as the host apparatus (represented by an IP address “192.0.0.1”), the operation data has been transmitted to the server unit 90 (represented by a port number “50000”) of the electronic whiteboard 2 as the host apparatus. In this case, the operation type is “STROKE,” the operation target is the page data represented by a page data ID “p005,” and the data as the contents of the operation data is the data representing the stroke. Further, the second row in FIG. 13 corresponding to a sequence number SEQ2 indicates that the server unit 90 (represented by the port number “50000”) of the electronic whiteboard 2 as the host apparatus (represented by the IP address “192.0.0.1”) has transmitted the operation data to the client unit 20 (represented by the port number “50001”) of another electronic whiteboard 2 as the participant apparatus (represented by an IP address “192.0.0.2”).

The operation data combining unit 84 combines the operation data items in the order of input of the operation data items to the operation data combining unit 84. Therefore, the stroke image B is displayed on the displays 3 of all electronic whiteboards 2 participating in the remote sharing process in the order of strokes rendered by the users of the electronic whiteboards 2, unless the communication network 9 is congested.

The page processing unit 85 has similar functions to those of the page processing unit 37 of the image processing unit 30 in the client unit 20. Therefore, the page data illustrated in FIGS. 6 to 8 is also stored in the page data storing unit 850 of the server unit 90. The page data storing unit 850 is similar in configuration to the page data storing unit 300 of the image processing unit 30, and thus description thereof will be omitted.

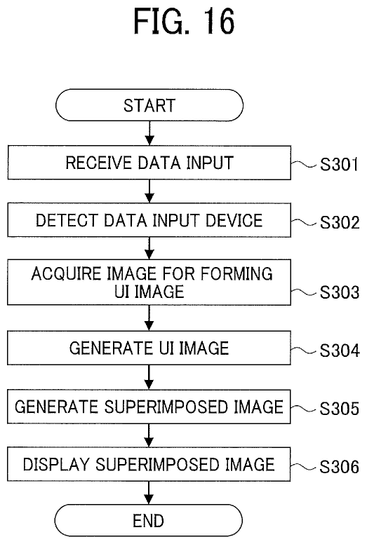

Processes of the electronic whiteboards 2 of the embodiment will be described with FIGS. 14 and 15.

In the example illustrated in FIGS. 14 and 15, the electronic whiteboard 2a (i.e., the server unit 90 and the client unit 20 thereof) functions as the host apparatus that hosts the remote sharing process, and each of electronic whiteboards 2b and 2c (i.e., the client unit 20 thereof) functions as the participant apparatus that participates in the remote sharing process.

In the present example, the electronic whiteboards 2a, 2b, and 2c include displays 3a, 3b, and 3c, respectively. Further, the electronic whiteboards 2a, 2b, and 2c are connected to laptop PCs 6a, 6b, and 6c, respectively, and electronic pens 4a, 4b, and 4c are used for the electronic whiteboards 2a, 2b, and 2c, respectively.

A process for the electronic whiteboards 2a and 2b to participate in the remote sharing process will be described with FIG. 14.

When the user of the electronic whiteboard 2a turns on a power switch of the electronic whiteboard 2a, the client unit 20 of the electronic whiteboard 2a is started. Then, the user performs an operation of starting the server unit 90 with the input device such as a touch panel, and the remote process starting unit 61 of the client unit 20 outputs an instruction to start the processing of the server unit 90 to the remote connection request receiving unit 71 of the server unit 90 in the electronic whiteboard 2a. Thereby, as well as the client unit 20, the server unit 90 is prepared to start various processes in the electronic whiteboard 2a (step S21).

Then, in the client unit 20 of the electronic whiteboard 2a, the UI image generating unit 33 generates connection information for the electronic whiteboards 2b and 2c to establish connection with the electronic whiteboard 2a, and the image superimposing unit 28 displays, on the display 3a, the connection information acquired from the UI image generating unit 33 via the display superimposing unit 36 (step S22).

The connection information includes the IP address of the electronic whiteboard 2a as the host apparatus and the passcode generated for the current remote sharing process. In this case, the passcode stored in the passcode managing unit 810 is read by the remote connection processing unit 81 in FIG. 12, and is transmitted to the remote connection result transmitting unit 72 and then to the remote process starting unit 61 of the communication control unit 60. The passcode is then transmitted from the communication control unit 60 to the image processing unit 30 in FIG. 11 to be input to the UI image generating unit 33 in FIG. 3. Thereby, the passcode is included in the connection information. The user of the electronic whiteboard 2a informs the users of the electronic whiteboards 2b and 2c of the connection information by telephone or electronic mail, for example. If the connection destination management table 440 is stored in the electronic whiteboards 2b and 2c, the electronic whiteboards 2b and 2c as the participant apparatuses are able to transmit the remote sharing process participation request to the electronic whiteboard 2a as the host apparatus, even if the IP address of the electronic whiteboard 2a as the host apparatus is not included in the connection information.

Then, in each of the electronic whiteboards 2b and 2c, in response to receipt of the connection information input by the user through the operation of the input device such as a touch panel, the remote process participation processing unit 62 of the client unit 20 transmits the passcode to the communication control unit 70 of the server unit 90 of the electronic whiteboard 2a via the communication network 9 based on the IP address included in the connection information (steps S23 and S24). Thereby, the remote connection request receiving unit 71 of the communication control unit 70 receives the remote sharing process participation request and the passcode from each of the electronic whiteboards 2b and 2c, and outputs the passcode to the remote connection processing unit 81.

Then, the remote connection processing unit 81 executes an authentication process on the passcodes received from the electronic whiteboards 2b and 2c based on the passcodes managed in the passcode managing unit 810 (step S25).

Then, the remote connection result transmitting unit 72 notifies each of the client units 20 of the electronic whiteboards 2b and 2c of a result of the authentication process (steps S26 and S27).

If it is determined in the authentication process of step S25 that each of the electronic whiteboards 2b and 2c is a valid electronic whiteboard 2, communication for the remote sharing process is established between the electronic whiteboard 2a as the host apparatus and the electronic whiteboards 2b and 2c as the participant apparatuses. In each of the client units 20 of the electronic whiteboards 2b and 2c, the remote process participation processing unit 62 prepares to start the remote sharing process with the other electronic whiteboards 2 (steps S28 and S29).

An output image display process included in the remote sharing process will be described with FIG. 14.

The electronic whiteboard 2b first displays the output image C on the display 3b (step S30). Specifically, the image acquiring unit 31 of the electronic whiteboard 2b receives the data of the output image C displayed on the laptop PC 6b from the laptop PC 6b via the image acquiring unit 21, and transmits the data of the output image C to the display 3b via the display superimposing unit 36 and the image superimposing unit 28. Thereby, the display 3b displays the output image C.

Then, in the electronic whiteboard 2b, the image processing unit 30 including the image acquiring unit 31 transmits the data of the output image C to the remote image transmitting unit 63 of the communication control unit 60. The communication control unit 60 then transmits the data of the output image C to the communication control unit 70 of the electronic whiteboard 2a as the host apparatus via the communication network 9 (step S31). Then, the remote image receiving unit 73 of the electronic whiteboard 2a receives the data of the output image C, and outputs the data of the output image C to the remote image processing unit 82, which then stores the data of the output image C in the image data storing unit 830.

Then, the electronic whiteboard 2a as the host apparatus displays the output image C on the display 3a (step S32). Specifically, the remote image processing unit 82 of the electronic whiteboard 2a receives the data of the output image C from the remote image receiving unit 73, and outputs the data of the output image C to the remote image transmitting unit 74

The remote image transmitting unit 74 then outputs the data of the output image C to the remote image receiving unit 64 of the client unit 20 in the electronic whiteboard 2a as the host apparatus. The remote image receiving unit 64 outputs the data of the output image C to the display superimposing unit 36, which then outputs the data of the output image C to the image superimposing unit 28. The image superimposing unit 28 outputs the data of the output image C to the display 3a. Thereby, the display 3a displays the output image C.

Then, in the server unit 90 of the electronic whiteboard 2a as the host apparatus, the communication control unit 70 including the remote image transmitting unit 74 transmits the data of the output image C to the communication control unit 60 of the electronic whiteboard 2c, i.e., the electronic whiteboard 2 other than the electronic whiteboard 2b that has originally transmitted the data of the output image C, via the communication network 9 (step S33). Then, the remote image receiving unit 64 of the electronic whiteboard 2c as the participant apparatus receives the data of the output image C.

Then, the electronic whiteboard 2c displays the output image C on the display 3c (step S34). Specifically, the remote image receiving unit 64 of the electronic whiteboard 2c outputs the data of the output image C received at step S33 to the display superimposing unit 36 of the electronic whiteboard 2c. The display superimposing unit 36 outputs the data of the output image C to the image superimposing unit 28, which then outputs the data of the output image C to the display 3c. Thereby, the display 3c displays the output image C. If the image superimposing unit 28 receives input of the data of the UI image A, the stroke image B, and the watermark image E, as well as the data of the output image C, the display superimposing unit 36 generates a superimposed image including the UI image A, the stroke image B, and the output image C superimposed upon each other (hereinafter referred to as the superimposed image ABC). Then, the image superimposing unit 28 outputs the data of the superimposed image ABC to the display 3c.

In this process, the watermark image E is not displayed. Further, if the data of an image for television conference (hereinafter referred to as the television conference image F) is transmitted to the image superimposing unit 28 from the television conference terminal 7, the image superimposing unit 28 superimposes the data of the television conference image F on the superimposed image ABC in the picture-in-picture format and outputs a resultant superimposed image to the display 3c.

The watermark image E is not transmitted or received between the host apparatus and the participant apparatus. Therefore, whether the watermark image E is displayed depends on each of the electronic whiteboards 2. Further, the watermark images E displayed by the electronic whiteboards 2 may be different (or the same) between the electronic whiteboards 2.

Further, watermark image data may be transmitted and received between the electronic whiteboards 2. Each of the electronic whiteboards 2 has a function of transmitting setting information describing settings related to the operation of the electronic whiteboard 2. The setting information includes, for example, settings for the electronic whiteboard 2 to appropriately operate (e.g., synchronization time and restart time), settings for allowing or restricting the operation of the electronic whiteboard 2 (i.e., settings related to security such as the passcode), ON-OFF settings of various functions, and settings for communication with the Internet or another apparatus via a network (e.g., the IP address). With the function of transmitting the setting information, the electronic whiteboards 2 are capable of sharing the watermark image data as well as the setting information.

A superimposed image display process included in the remote sharing process will be described with FIG. 15.

The user of the electronic whiteboard 2b first renders the stroke image B on the electronic whiteboard 2b with the electronic pen 4b (step S41).

Then, the display superimposing unit 36 of the electronic whiteboard 2b superimposes the stroke image B on the UI image A and the output image C, as illustrated in FIG. 4, to display the superimposed image ABC on the display 3b of the electronic whiteboard 2b (step S42). Specifically, the stroke processing unit 32 of the electronic whiteboard 2b receives the data of the stroke image B as the operation data from the coordinate detecting unit 22 and the contact detecting unit 24 via the event sorting unit 25, and transmits the data of the stroke image B to the display superimposing unit 36. Thereby, the display superimposing unit 36 superimposes the stroke image B on the UI image A and the output image C, and the image superimposing unit 28 displays the superimposed image ABC on the display 3b of the electronic whiteboard 2b.

Then, in the electronic whiteboard 2b, the image processing unit 30 including the stroke processing unit 32 transmits the data of the stroke image B to the remote operation transmitting unit 65, which then transmits the data of the stroke image B to the communication control unit 70 of the electronic whiteboard 2a as the host apparatus via the communication network 9 (step S43).

Then, the remote operation receiving unit 75 of the electronic whiteboard 2a receives the data of the stroke image B, and outputs the data of the stroke image B to the remote operation processing unit 83, which then outputs the data of the stroke image B to the operation data combining unit 84. When the electronic whiteboard 2b renders a plurality of strokes as the stroke image B, a plurality of data items of the stroke image B are sequentially transmitted to the remote operation processing unit 83 of the electronic whiteboard 2a as the host apparatus, as described above.

The data of the stroke image B correspond to the data items represented by the stroke data IDs illustrated in FIG. 7. For example, therefore, when a user writes the alphabetic letter “T” with the electronical pen 4, the letter “T” is normally written in two strokes, as described above. Thus, two data items represented by two stroke data IDs are sequentially transmitted as the data of the stroke image B.

Then, the electronic whiteboard 2a as the host apparatus receives the superimposed image ABC with the data of the stroke image B from the electronic whiteboard 2b, and displays the superimposed image ABC with the data of the stroke image B on the display 3a (step S44). Specifically, the operation data combining unit 84 of the electronic whiteboard 2a combines the data items of the stroke image B sequentially transmitted via the remote operation processing unit 83. The operation data combining unit 84 then stores the combined data items in the operation data storing unit 840, and transmits the combined data items back to the remote operation processing unit 83.

Then, the remote operation processing unit 83 outputs, to the remote operation transmitting unit 76, the combined data items of the stroke image B received from the operation data combining unit 84. The remote operation transmitting unit 76 outputs the combined data items of the stroke image B to the remote operation receiving unit 66 of the client unit 20 in the electronic whiteboard 2a as the host apparatus.

The remote operation receiving unit 66 outputs the combined data items of the stroke image B to the display superimposing unit 36 of the image processing unit 30. Then, the display superimposing unit 36 superimposes the combined data items of the stroke image B on the UI image A and the output image C. Finally, the image superimposing unit 28 displays, on the display 3a, the superimposed image ABC including the UI image A, the stroke image B, and the output image C superimposed by the display superimposing unit 36.

Then, in the server unit 90 of the electronic whiteboard 2a as the host apparatus, the communication control unit 70 including the remote operation transmitting unit 76 transmits the combined data items of the stroke image B to the communication control unit 60 of the electronic whiteboard 2c, i.e., the electronic whiteboard 2 other than the electronic whiteboard 2b that has originally transmitted the data items of the stroke image B, via the communication network 9 (step S45). Then, the remote operation receiving unit 66 of the electronic whiteboard 2c as a participant apparatus receives the combined data items of the stroke image B.

Then, the electronic whiteboard 2c displays the superimposed image ABC on the display 3c (step S46). Specifically, the remote operation receiving unit 66 of the electronic whiteboard 2c outputs the combined data items of the stroke image B received at step S45 to the image processing unit 30 of the electronic whiteboard 2c. The display superimposing unit 36 of the image processing unit 30 superimposes the data of the UI image A, the combined data items of the stroke image B, and the data of the output image C upon each other, and outputs the data of the resultant superimposed image ABC to the image superimposing unit 28. The image superimposing unit 28 outputs the data of the superimposed image ABC to the display 3c. Thereby, the display 3c displays the superimposed image ABC.

In the above-described process, the output image C is displayed on the display 3. Alternatively, the display 3 may display the background image D in place of the output image C. Further, the exclusive relationship between the output image C and the background image D may be cancelled to enable the display 3 to display both the output image C and the background image D at the same time.

A process for a participant apparatus to terminate the participation in the remote sharing process will be described with FIG. 15.

FIG. 15 illustrates an exemplary process of terminating the participation of the electronic whiteboard 2c in the remote sharing process.

In the electronic whiteboard 2c, in response to receipt of a participation termination request input by the user through the operation of the input device such as a touch panel, the remote process participation processing unit 62 transmits the participation termination request to the communication control unit 70 of the server unit 90 of the electronic whiteboard 2a as the host apparatus (step S47).

Then, the remote connection request receiving unit 71 of the communication control unit 70 receives the participation termination request from the electronic whiteboard 2c, and outputs the participation termination request to the remote connection processing unit 81 together with the IP address of the electronic whiteboard 2c. Then, based on the IP address transmitted from the remote connection request receiving unit 71, the remote connection processing unit 81 of the electronic whiteboard 2a deletes, from the participant site management table 820, the IP address of the electronic whiteboard 2c having transmitted the participation termination request and the name of the site of the electronic whiteboard 2c. The remote connection processing unit 81 then outputs, to the remote connection result transmitting unit 72, a notification indicating that the IP address of the electronic whiteboard 2c and the name of the site of the electronic whiteboard 2c have been deleted.

Then, the communication control unit 70 including the remote connection result transmitting unit 72 transmits a participation termination instruction to the communication control unit 60 of the client unit 20 of the electronic whiteboard 2c via the communication network 9 (step S48). Then, the remote process participation processing unit 62 of the communication control unit 60 in the electronic whiteboard 2c executes a participation termination process by cutting off the communication for the remote sharing process, to thereby terminate the participation of the electronic whiteboard 2c in the remote sharing process (step S49). The process for a participant apparatus to terminate the participation in the remote sharing process is thus executed.

A description will be given of a process in which the electronic whiteboard 2 receives data input from an external apparatus and displays the UI image A on the display surface 301. In the following description of this process, a part of the process of displaying the output image C at step S30 in FIG. 14 will be described in more detail.

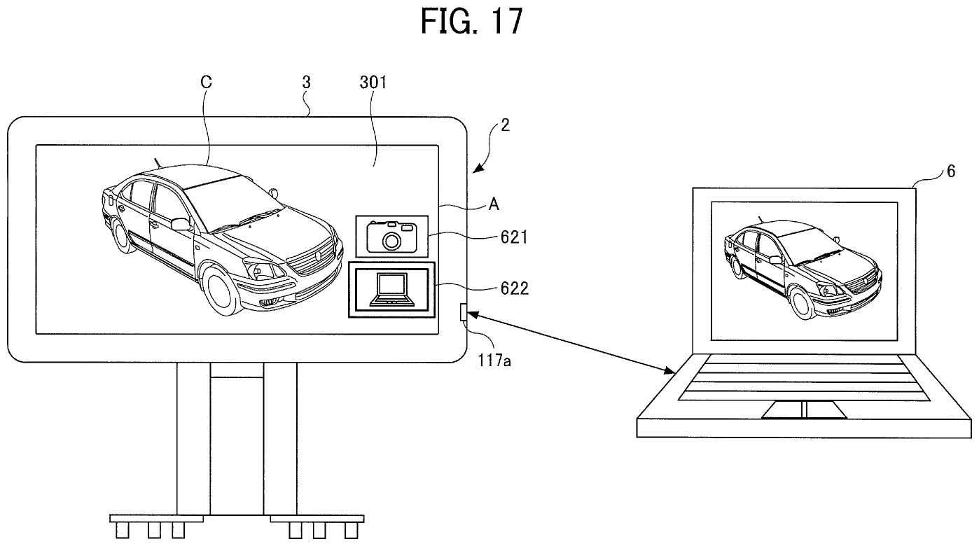

FIG. 16 is a flowchart illustrating an exemplary process in which the electronic whiteboard 2 receives data input from an external apparatus and displays the UI image A on the display surface 301. As illustrated in FIG. 16, the electronic whiteboard 2 first receives input of data such as image data from an external apparatus such as the laptop PC 6 via a data input device such as the wired port 117a (step S301).

Then, the input detecting unit 33a detects the data input device having received the data input, and outputs the identification information of the detected data input device to the UI image generating unit 33 (step S302).

Based on the identification information input from the input detecting unit 33a, the UI image generating unit 33 then acquires the image for forming the UI image by referring to the table illustrated in FIG. 5A or 5B (step S303).

Then, the UI image generating unit 33 generates the UI image A with the acquired image, and outputs the UI image A to the display superimposing unit 36 (step S304).

The display superimposing unit 36 then generates a superimposed image including the input UI image A, and outputs the superimposed image to the image superimposing unit 28 (step S305).

Then, the image superimposing unit 28 displays the superimposed image including the UI image A on the display surface 301 (step S306).

The electronic whiteboard 2 thus displays, on the display surface 301, the UI image A generated based on the data input from the external apparatus.

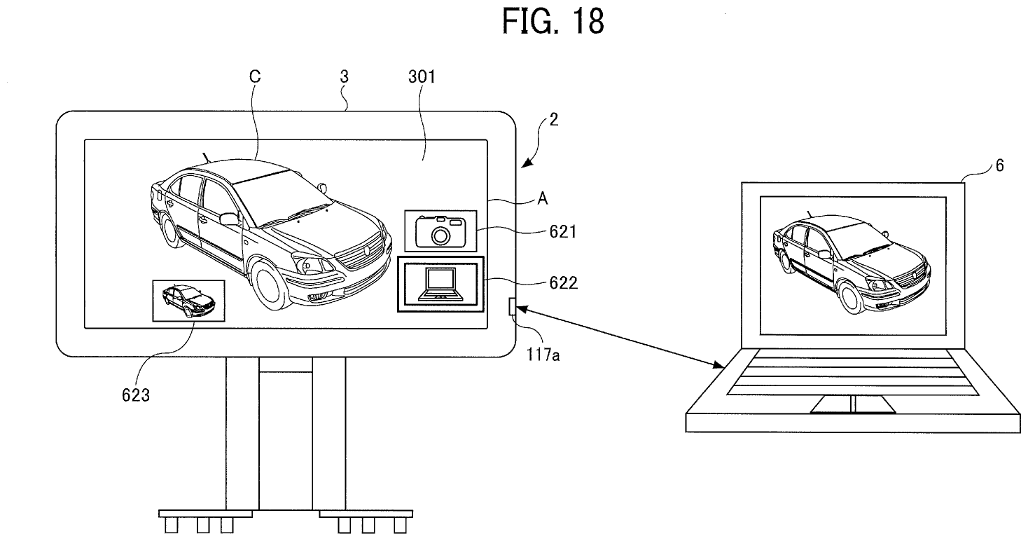

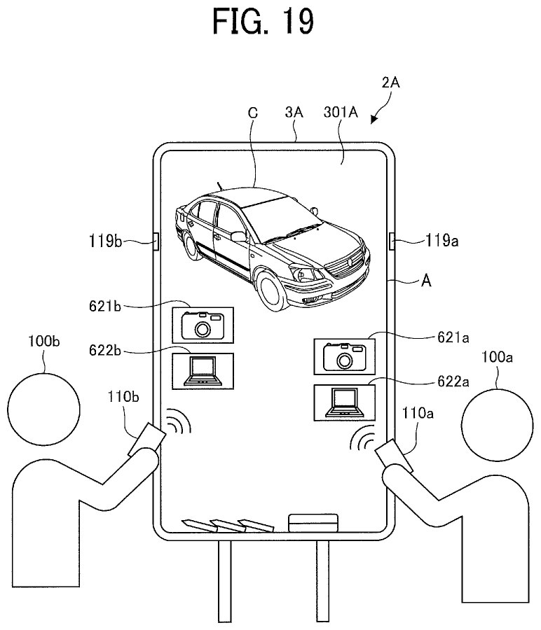

Examples of the superimposed image of the embodiment will be described with FIGS. 17 and 18.

FIG. 17 is a diagram illustrating an example of the superimposed image displayed when an external apparatus is connected to the right side of the electronic whiteboard 2. In FIG. 17, the laptop PC 6 is connected, via a cable, to the wired port 117a disposed on the right side of the electronic whiteboard 2. Herein, the right side refers to the right side in FIG. 17.

The superimposed image including the output image C and the UI image A superimposed upon each other is displayed on the display surface 301 of the display 3. Specifically, the output image C is displayed at the center of the display surface 301 of the display 3, and a camera UI 621 and an image UI 622 included in the UI image A are displayed on the right side of the display surface 301 of the display 3.

More specifically, in the electronic whiteboard 2, the input detecting unit 33a detects the connection of the laptop PC 6 to the wired port 117a, and outputs the identification information of the wired port 117a to the UI image generating unit 33. In accordance with the input identification information, the UI image generating unit 33 generates the UI image A with the camera UI 621 and the image UI 622 arranged on the right side thereof, and outputs the UI image A to the display superimposing unit 36. The display superimposing unit 36 generates the superimposed image including the input UI image A, and the image superimposing unit 28 displays the superimposed image including the UI image A on the display surface 301. Thereby, the camera UI 621 and the image UI 622 are displayed on the right side of the display surface 301. Herein, each of the camera UI 621 and the image UI 622 is an example of the instruction receiving section.

The camera UI 621 is a user interface for storing the output image C in the electronic whiteboard 2 as a still image. When the user performs the UI operation on the camera UI 621 on the display surface 301, the output image C displayed on the display surface 301 is stored in a memory of the electronic whiteboard 2 such as the SSD 104 as a still image. Herein, the output image C is an example of screen data.

The image UI 622 is a user interface for inputting the image of the laptop PC 6 to the electronic whiteboard 2. When the user performs the UI operation on the image UI 622 on the display surface 301, the image displayed on a display of the laptop PC 6 is input to the electronic whiteboard 2 and displayed on the display surface 301.

FIG. 17 illustrates an example in which the laptop PC 6 is connected to the wired port 117a on the right side of the electronic whiteboard 2. However, the connection of the laptop PC 6 is not limited to this example. The laptop PC 6 may be connected to a wired port disposed on the left side of the electronic whiteboard 2. In this case, based on the identification information of the wired port detected to be connected to the laptop PC 6 by the input detecting unit 33a, the UI image generating unit 33 generates the UI image A with the camera UI 621 and the image UI 622 arranged on the left side thereof, and the image superimposing unit 28 displays a superimposed image including the UI image A on the display surface 301. Thereby, the camera UI 621 and the image UI 622 are displayed on the left side of the display surface 301.

Further, one laptop PC 6 may be connected to a wired port on the left side of the electronic whiteboard 2, and another laptop PC 6 may be connected to a wired port on the right side of the electronic whiteboard 2. In this case, based on the identification information of each of these wired ports detected to be connected to the laptop PCs 6 by the input detecting unit 33a, the UI image generating unit 33 generates the UI image A with the camera UI 621 and the image UI 622 arranged on both the right and left sides thereof, and the image superimposing unit 28 displays the UI image A on the display surface 301. Thereby, the camera UI 621 and the image UI 622 are displayed on both the right and left sides of the display surface 301.

Further, a plurality of external apparatuses may be connected to a plurality of data input devices of the electronic whiteboard 2, and a priority may be set for each of identification information items of the data input devices. In this case, based on the identification information item of the highest priority among the identification information items of the data input devices detected by the input detecting unit 33a, the UI image generating unit 33 generates the UI image A with the camera UI 621 and the image UI 622 arranged on one side of the electronic whiteboard 2 equipped with the data input device corresponding to the identification information of the highest priority, and the image superimposing unit 28 displays a superimposed image including the UI image A on the display surface 301. Thereby, the camera UI 621 and the image UI 622 are displayed on one side of the display surface 301 near the data input device corresponding to the identification information of the highest priority.

FIG. 17 illustrates the camera UI 621 and the image UI 622 as examples of the UI included in the UI image A. Examples of the UI included in the UI image A, however, are not limited thereto. For example, the UI image A may include a UI for setting parameters such as the color and width of the line rendered with the electronic pen 4.

FIG. 18 is a diagram illustrating an example of the superimposed image displayed when the output image C is stored in the electronic whiteboard 2 as a still image. When the user performs the UI operation on the camera UI 621 on the display surface 301, the output image C is stored in a memory of the electronic whiteboard 2 as a still image, and a thumbnail image 623 of the stored output image C is displayed in a lower-left area of the display surface 301.

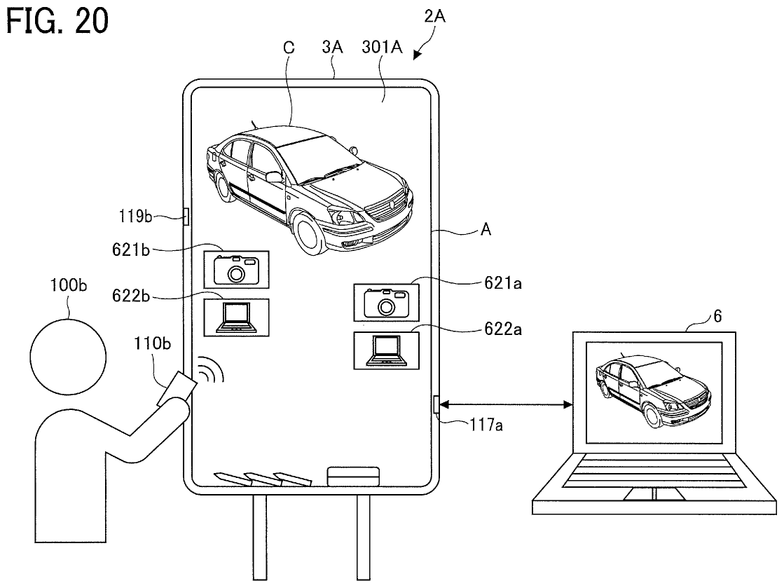

An operation of an electronic whiteboard 2A according to another embodiment of the present invention will be described with FIGS. 19 and 20. Description of the same components as those of the above-described embodiment will be omitted.

FIG. 19 is a diagram illustrating an exemplary operation of the electronic whiteboard 2A of the present embodiment. FIG. 19 illustrates an example of the superimposed image displayed when a plurality of image output apparatuses are wirelessly connected to the electronic whiteboard 2A. In the following description with FIG. 19 and the subsequent drawings, the right and left sides refer to the right and left sides in the drawings.

As illustrated in FIG. 19, the electronic whiteboard 2A includes a vertically long display 3A with a display surface 301A. Further, the right side in the horizontal direction of the electronic whiteboard 2A is equipped with an antenna 119a, and the left side in the horizontal direction of the electronic whiteboard 2A is equipped with an antenna 119b. The antenna 119a is an example of one data input device of at least two data input devices, and the antenna 119b is an example of other data input device of the at least two data input devices. Further, the antennas 119a and 119b are an example of one data input device and other data input device of the at least two data input devices. Each of the antennas 119a and 119b wirelessly receives data input.

A user 100a holds a smartphone 110a, and a user 100b holds a smartphone 110b. Each of the smartphones 110a and 110b is capable of outputting an image to outside thereof, and is also capable of outputting a file such as an image file to the electronic whiteboard 2A.

The smartphone 110a held by the user 100a is connected to the electronic whiteboard 2A via the antenna 119a, and the smartphone 110b held by the user 100b is connected to the electronic whiteboard 2A via the antenna 119b.

The input detecting unit 33a detects the connection of one external apparatus to the right side of the electronic whiteboard 2A via the antenna 119a and the connection of another external apparatus to the left side of the electronic whiteboard 2A via the antenna 119b. The input detecting unit 33a outputs the identification information of each of the antennas 119a and 119b to the UI image generating unit 33. Based on the input identification information, the UI image generating unit 33 generates the UI image A with a camera UI 621a and an image UI 622a arranged on the right side thereof and a camera UI 621b and an image UI 622b arranged on the left side thereof.

Further, the image acquiring unit 21 acquires the output image C from the smartphone 110a via the antenna 119a. Alternatively, the image acquiring unit 21 may acquire the output image C from the smartphone 110b via the antenna 119b.

The display superimposing unit 36 outputs, to the image superimposing unit 28, a superimposed image including the UI image A and the output image C superimposed upon each other. The image superimposing unit 28 displays the input superimposed image on the display surface 301A of the display 3A.

In the example of FIG. 19, both of the one data input device and the other data input device (i.e., the antennas 119a and 119b) wirelessly receive data input, but may receive data input by wire.

FIG. 20 is a diagram illustrating another exemplary operation of the electronic whiteboard 2A of the present embodiment. FIG. 20 illustrates an example of the superimposed image displayed when one image output apparatus is connected by wire to one side of the electronic whiteboard 2A and another image output apparatus is wirelessly connected to the other side of the electronic whiteboard 2A.

The right side of the electronic whiteboard 2A is equipped with the wired port 117a, and the left side of the electronic whiteboard 2A is equipped with the antenna 119b. The wired port 117a is an example of the one data input device, and receives data input by wire. The antenna 119b is an example of the other data input device, and wirelessly receives data input.

As illustrated in FIG. 20, the laptop PC 6 is connected to the right side of the electronic whiteboard 2A via a cable, and the smartphone 110b held by the user 100b is connected to the left side of the electronic whiteboard 2A via the antenna 119b.

The input detecting unit 33a detects the connection of one external apparatus to the right side of the electronic whiteboard 2A via the wired port 117a and the connection of another external apparatus to the left side of the electronic whiteboard 2A via the antenna 119b. The input detecting unit 33a outputs the identification information of each of the wired port 117a and the antenna 119b to the UI image generating unit 33.

Based on the input identification information, the UI image generating unit 33 generates the UI image A with the camera UI 621a and the image UI 622a arranged on the right side thereof and the camera UI 621b and the image UI 622b arranged on the left side thereof.

Further, the image acquiring unit 21 acquires the output image C from the laptop PC 6 via the wired port 117a. Alternatively, the image acquiring unit 21 may acquire the output image C from the smartphone 110b via the antenna 119b.

The display superimposing unit 36 outputs, to the image superimposing unit 28, a superimposed image including the UI image A and the output image C superimposed upon each other. The image superimposing unit 28 displays the input superimposed image on the display surface 301A of the display 3A.

Normally, a user of an electronic whiteboard makes a presentation, for example, while standing by one side of the electronic whiteboard to avoid blocking the image displayed on the electronic whiteboard. During the presentation, the user may want to perform the UI operation such as inputting an image from an image output apparatus to the electronic whiteboard or setting parameters such as the color and width of the line rendered with an electronic pen, for example.

A typical electronic whiteboard displays UIs on one side (e.g., right side) of the electronic whiteboard irrespective of the standing position of the user. Therefore, when the user makes a presentation while standing by the other side (e.g., left side) of the electronic whiteboard, for example, the user may reach out a hand to the displayed UIs while avoiding blocking the display surface of the electronic whiteboard or move to the display position of the UIs to perform the UI operation. Such an electronic whiteboard is inconvenient for the user to perform the UI operation.

Although there is an electronic whiteboard enabling the user to change the display position of the UIs by changing user settings, this type of electronic whiteboard causes the user extra work of changing the settings. Further, the user may be unaware of how to change the display position of the UIs.

According to the electronic whiteboard 2A of the present embodiment, on the other hand, when the user stands by the right side of the electronic whiteboard 2A, data is input to the electronic whiteboard 2A from the right side thereof near the user. The electronic whiteboard 2A then displays the UIs such as the camera UI 621a and the image UI 622a on the right side of the display surface 301A, i.e., the right side of the electronic whiteboard 2A to which the data is input. When the user stands by the left side of the electronic whiteboard 2A, data is input to the electronic whiteboard 2A from the left side thereof near the user. The electronic whiteboard 2A then displays the UIs on the left side of the display surface 301A, i.e., the left side of the electronic whiteboard 2A to which the data is input.

Thereby, the user is able to perform the UI operation on the UIs displayed at a position close to the user. The present embodiment provides a display apparatus (e.g., the electronic whiteboard 2A) that facilitates the user to perform the UI operation (i.e., input the instruction) without reaching out a hand to the UIs by avoiding blocking the display surface of the display apparatus or without moving to the display position of the UIs.

In the present embodiment, the data input devices are disposed on the right and left sides of the display surface 301A. Alternatively, the data input devices may be disposed on the upper and lower sides of the display surface 301A. In this case, if data is input to a data input device disposed on the lower side of the display surface 301A, for example, the UIs are displayed in a lower-central area of the display surface 301A. Further, if data is input to a data input device disposed on the upper side of the display surface 301A, the UIs are displayed in an upper-central area of the display surface 301A.

An electronic whiteboard 2B according to another embodiment of the present invention will be described. Description of the same components as those of the above-described embodiments will be omitted.

The electronic whiteboard 2B of the present embodiment includes a UI for switching between display and non-display of UIs.

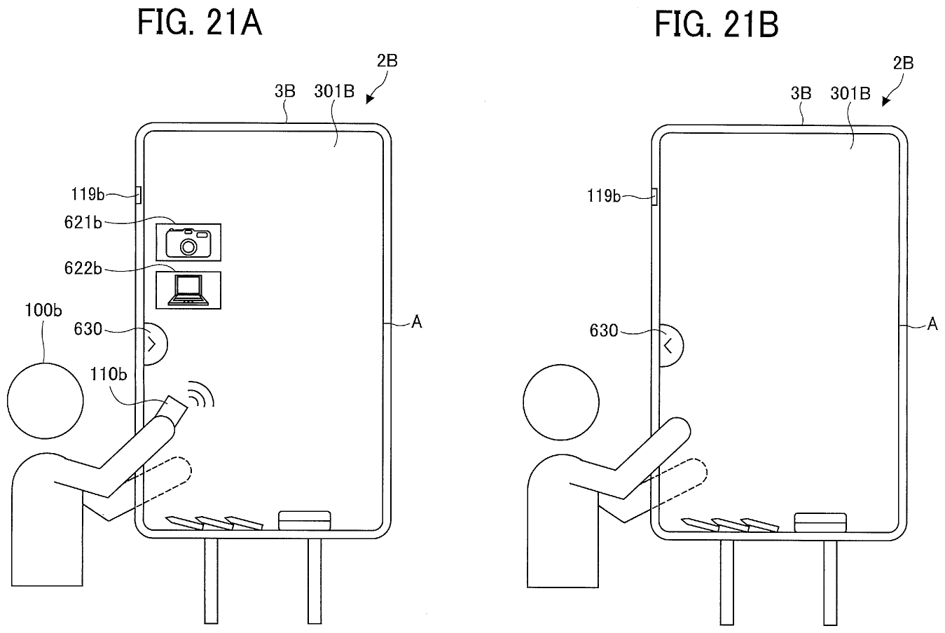

FIGS. 21A and 21B are diagrams illustrating exemplary operations of the electronic whiteboard 2B of the present embodiment. FIG. 21A illustrates the electronic whiteboard 2B with the UIs displayed thereon, and FIG. 21B illustrates the electronic whiteboard 2B with the UIs not displayed thereon.

The electronic whiteboard 2B includes a display 3B with a display surface 301B. The display surface 301B displays a switching UI 630. The switching UI 630 is an example of a switching instruction receiving section. The switching UI 630 is a user interface for switching between display and non-display of the UIs arranged on the left side of the display surface 301B.

In FIG. 21A, when the user 100b holding the smartphone 110b stands by the left side of the electronic whiteboard 2B, the smartphone 110b is connected to the electronic whiteboard 2B via the antenna 119b.

The image superimposing unit 28 displays, on the display surface 301B, a superimposed image including the UI image A with the camera UI 621b and the image UI 622b arranged on the left side thereof. The UI image A is generated by the UI image generating unit 33 based on the identification information of the data input device detected to be connected to the smartphone 110b by the input detecting unit 33a.

The camera UI 621b and the image UI 622b are displayed on the left side of the display surface 301B. When the user performs the UI operation on the switching UI 630 in this state, the camera UI 621b and the image UI 622b are switched to an undisplayed state. The camera UI 621b, the image UI 622b, and the switching UI 630 are an example of a plurality of instruction receiving sections.

As a result of the UI operation, the camera UI 621b and the image UI 622b on the display surface 301B are brought into the undisplayed state, as illustrated in FIG. 21B. If many UIs are displayed on the display surface 301B, it may be difficult for a viewer to clearly see a diagram drawn with the electronic pen 4 or the user's hand H or the output image displayed on the display surface 301B, for example. Such difficulty in seeing the diagram or image due to the display of the UIs is removed by bringing the UIs displayed on the display surface 301B into the undisplayed state.

When the user performs the UI operation on the switching UI 630 in the state of FIG. 21B, the camera UI 621b and the image UI 622b are displayed to return to the state of FIG. 21A.

In the state of FIG. 21B, the camera UI 621b and the image UI 622b are not displayed; the user is unable to perform the UI operation thereon. By returning the camera UI 621b and the image UI 622b to the state of FIG. 21A, the user is again able to perform the UI operation on the camera UI 621b and the image UI 622b.

As described above, the electronic whiteboard 2B of the present embodiment includes the switching UI 630 to switch between display and non-display of the UIs on the display surface 301B. Thereby, the difficulty in seeing the diagram or image, for example, due to the display of the UIs is removed, thereby facilitating communication using the electronic whiteboard 2B. As well as this effect, the above-described effects of the foregoing embodiments are also provided by the present embodiment.

The electronic whiteboard 2 according to one of the foregoing embodiments is connected to the laptop PC 6 by wire. Alternatively, the electronic whiteboard 2 may be wirelessly connected to the laptop PC 6 to input the image from the laptop PC 6 to the electronic whiteboard 2. In this case, whether the image is input to the electronic whiteboard 2 is determined based on whether the image is received by a communication device for a wireless network such as a wireless LAN.

The embodiment is applicable not only to one-to-one connection or communication between the laptop PC 6 and the electronic whiteboard 2 but also to communication therebetween via a wired or wireless network.

In the configuration examples illustrated in FIG. 3 and other drawings, the processing units are divided in accordance with major functions of the electronic whiteboard 2 to facilitate the understanding of the processing of the electronic whiteboard 2. The present invention, however, is not limited by how the processing units are divided or the names of the processing units. The processing of the electronic whiteboard 2 may be divided into a larger number of processing units depending on processes to be performed. Further, a processing unit of the electronic whiteboard 2 may be sub-divided to include more processes.

Each of the display apparatuses of the above-described embodiments may be implemented by a device memory storing one or more programs and one or more processors. The one or more processors may execute the one or more programs to execute the processes described above in the embodiments. For example, with the device memory and the one or more processors, the functions described above in the embodiments may be implemented. The device memory and the one or more processors may be implemented by the hardware components described above in the embodiments, for example. Further, one or more programs for causing a computer such as a display apparatus to execute processes may be stored in a nonvolatile recording medium.

According to another embodiment of the present invention, a display method is provided. For example, the display method is executed by a display apparatus including a display with a display surface and at least two data input devices. The display method includes detecting, from the at least two data input devices, a data input device to which data is input, generating an instruction receiving image including an instruction receiving section to receive an instruction from a user, and displaying the instruction receiving image on the display surface. The instruction receiving section is arranged at a position according to a result of the detecting.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Circuitry includes a programmed processor, as a processor includes circuitry. A processing circuit also includes devices such as an application specific integrated circuit (ASIC), digital signal processor (DSP), section programmable gate array (FPGA), and conventional circuit components arranged to perform the recited functions. Further, the above-described steps are not limited to the order disclosed herein.

1. A display apparatus comprising:
a display with a display surface;
at least two data input devices; and
circuitry configured to
detect, from the at least two data input devices, a data input device to which data is input,
generate an instruction receiving image including an instruction receiving section to receive an instruction from a user, the instruction receiving section being arranged at a position according to a result of the detection, and
display the instruction receiving image on the display surface.

2. The display apparatus of claim 1, wherein the circuitry detects a position on the display surface at which contact is made.

3. The display apparatus of claim 1, wherein the at least two data input devices are disposed on two opposing sides of the display surface.

4. The display apparatus of claim 1, wherein the circuitry outputs identification information of the data input device to which the data is input.

5. The display apparatus of claim 1, wherein each of the at least two data input devices is assigned with identification information of a certain priority, and
wherein in response to detection of input of data to the at least two data input devices, the circuitry generates the instruction receiving image in accordance with the certain priority of the identification information.

6. The display apparatus of claim 3, wherein when data is input to one data input device of the at least two data input devices, the circuitry displays the instruction receiving image with the instruction receiving section arranged at one position on the display surface near the one data input device, and
wherein when data is input to other data input device of the at least two data input devices, the circuitry displays the instruction receiving image with the instruction receiving section arranged at another position on the display surface near the other data input device.

7. The display apparatus of claim 3, wherein when data is input to one data input device and other data input device of the at least two data input devices, the circuitry displays the instruction receiving image with the instruction receiving section arranged at one position on the display surface near the one data input device and at another position on the display surface near the other data input device.

8. The display apparatus of claim 6, wherein the instruction receiving section receives at least one of an instruction to input the data to the display apparatus from an external apparatus and an instruction to store screen data displayed on the display surface into the display apparatus.

9. The display apparatus of claim 6, wherein the data is input by wire or wirelessly to the one data input device and the other data input device.

10. The display apparatus of claim 6, wherein the data is input by wire to the one data input device, and the data is wirelessly input to the other data input device.

11. The display apparatus of claim 6, wherein the instruction receiving section includes a plurality of instruction receiving sections including a switching instruction receiving section, and
wherein the switching instruction receiving section receives an instruction to switch between display and non-display of part of the plurality of instruction receiving sections on the display surface.

12. The display apparatus of claim 6, wherein the instruction receiving section receives the instruction from the user via a pointer.

13. The display apparatus of claim 1, wherein each of the at least two data input devices is configured to receive input of an image signal from an external apparatus.

14. The display apparatus of claim 1, wherein each of the at least two data input devices is configured to receive input of a certain type of data file from an external apparatus.

15. The display apparatus of claim 1, wherein each of the at least two data input devices is configured to receive input of a user-specified file from an external apparatus.

16. A display method executed by a display apparatus,
the display apparatus including
a display with a display surface, and
at least two data input devices, and
the display method comprising:
detecting, from the at least two data input devices, a data input device to which data is input;
generating an instruction receiving image including an instruction receiving section to receive an instruction from a user, the instruction receiving section being arranged at a position according to a result of the detecting; and
displaying the instruction receiving image on the display surface.
